(19) United States
(12) Patent Application Publication
(10) Pub. No.: US 2026/0199790 A1
(43) Pub. Date: Jul. 16, 2026

(54) GAME PROCESSING METHOD AND APPARATUS, DEVICE, MEDIUM, AND PROGRAM PRODUCT

(71) Applicant: Tencent Technology (Shenzhen) Company Limited, Shenzhen (CN)

(72) Inventor: Yunpeng GUO, Shenzhen (CN)

(21) Appl. No.: 19/562,492

(22) Filed: Mar. 10, 2026

Related U.S. Application Data
(63) Continuation of application No. PCT/CN2024/136462, filed on Dec. 3, 2024.

(30) Foreign Application Priority Data
Jan. 6, 2024 (CN) 202410023013.4

(51) Int. Cl. A63F 13/69; A63F 13/2145; A63F 13/533; A63F 13/58; A63F 13/822

(52) U.S. Cl. CPC A63F 13/69; A63F 13/2145; A63F 13/533; A63F 13/58; A63F 13/822

(57) ABSTRACT

Embodiments of this application provide a game processing method performed by a computer device. The method includes: displaying a first virtual prop obtained by a virtual character in a virtual scene; receiving a selection operation on a second virtual prop among at least one candidate virtual prop; and transferring a skill special effect set of the second virtual prop to the first virtual prop. Embodiments of this application can implement special effect transfer between different virtual props, thereby improving flexibility of cultivating a virtual prop.

### CROSS-REFERENCE TO RELATED APPLICATIONS

This application is a continuation application of PCT Patent Application No. PCT/CN2024/136462, entitled “GAME PROCESSING METHOD AND APPARATUS, DEVICE, MEDIUM, AND PROGRAM PRODUCT” filed on Dec. 3, 2024, which claims priority to Chinese Patent Application No. 2024100230134, entitled “GAME PROCESSING METHOD AND APPARATUS, DEVICE, MEDIUM, AND PROGRAM PRODUCT” filed with the China National Intellectual Property Administration on Jan. 6, 2024, all of which are incorporated herein by reference in their entirety.

### TECHNICAL FIELD

This application relates to the field of computer technologies, in particular, to the field of game processing, and specifically, to a game processing method, a game processing apparatus, a computer device, a computer-readable storage medium, and a computer program product.

### BACKGROUND

A virtual prop is a cultivation pursuit with wide applicability in various games, and is also a cultivation system that a gamer feels most strongly after playing a game. A gamer is usually willing to pay for a virtual prop to obtain a higher-level (or higher-quality) virtual prop, thereby improving a game capability of a virtual character controlled by the gamer in a virtual scene.

Currently, different virtual props can be cultivated in a game in an independent cultivation mode. For example, when a gamer has two virtual props of different levels at the same time, the gamer needs to weigh which virtual prop to cultivate, resulting in fragmented cultivation of different virtual props in a game, causing limitations on cultivation of the virtual props, and degrading game experience of the gamer.

### SUMMARY

Embodiments of this application provide a game processing method and apparatus, a device, a medium, and a program product, which can implement special effect transfer between different virtual props, thereby improving flexibility of cultivating a virtual prop.

According to one aspect, an embodiment of this application provides a game processing method performed by a computer device, and the method including:
displaying a first virtual prop obtained by a virtual character in a virtual scene, the virtual character being associated with at least one candidate virtual prop, and a prop type of the candidate virtual prop being the same as a prop type of the first virtual prop;
receiving a selection operation on a second virtual prop in the at least one candidate virtual prop, the second virtual prop having a skill special effect set, the skill special effect set including a special effect resource corresponding to a game skill; and
transferring the skill special effect set of the second virtual prop to the first virtual prop, wherein the virtual character equipped with the first virtual prop, when using the game skill in the virtual scene, has skill strength that matches the special effect resource.

According to another aspect, an embodiment of this application provides a computer device, including:
a processor, configured to load and execute a computer program; and
a computer-readable storage medium, having the computer program stored therein, the computer program, when executed by the processor, implementing the foregoing game processing method.

According to another aspect, this application provides a non-transitory computer-readable storage medium, having a computer program stored therein, the computer program being configured to be loaded by a processor to perform the foregoing game processing method.

In embodiments of this application, a first virtual prop obtained by a virtual character in a virtual scene may be displayed on a computer device, and the first virtual prop is used as a virtual prop that is to receive a special effect, the virtual character being associated with at least one candidate virtual prop, and a prop type of the candidate virtual prop being the same as a prop type of the first virtual prop. Further, a gamer may perform a selection operation on a second virtual prop in the at least one candidate virtual prop in the computer device. In this case, the selected second virtual prop is used as a virtual prop from which a special effect is to be transferred, and the computer device transfers a skill special effect set of the selected second virtual prop to the first virtual prop, the second virtual prop being a virtual prop that a gamer has cultivated, the second virtual prop having the skill special effect set that has been cultivated, and the virtual character equipped with the second virtual prop, when using a game skill in a virtual scene, having skill strength that matches a special effect resource included in the skill special effect set. Based on this, after the skill special effect set is transferred, the first virtual prop has the skill special effect set, and the virtual character equipped with the first virtual prop, when using the game skill in the virtual scene, has skill strength that matches the special effect resource included in the skill special effect set. The skill special effect set of the second virtual prop that has been cultivated is transferred to the first virtual prop, thereby preventing the first virtual prop from being cultivated from the very beginning, avoiding fragmented cultivation between different virtual props in a conventional game, and improving flexibility of transferring a skill special effect set between virtual props. In addition, when the skill special effect set of the second virtual prop is transferred to the first virtual prop, a special effect resource in the skill special effect set is not lost, thereby implement lossless effect transfer of a skill special effect set between virtual props, and improving prop cultivation experience of a gamer.

### BRIEF DESCRIPTION OF DRAWINGS

FIG. 1 is a diagram of an architecture of a game processing system according to an exemplary embodiment of this application.

FIG. 2 is a schematic flowchart of a game processing method according to an exemplary embodiment of this application.

FIG. 3 is a diagram of triggering to display a virtual prop interface by using a second access component according to an exemplary embodiment of this application.

FIG. 4 is a diagram of selecting a first virtual prop from a prop selection region according to an exemplary embodiment of this application.

FIG. 5 is a diagram of triggering to display a virtual prop interface by using a prop prompt window according to an exemplary embodiment of this application.

FIG. 6 is a diagram of dynamically setting an optional status of a decoration option according to an exemplary embodiment of this application.

FIG. 7 is a diagram of outputting prompt information according to an exemplary embodiment of this application.

FIG. 8 is a diagram of selecting a second virtual prop by using a prop selection option according to an exemplary embodiment of this application.

FIG. 9 is a diagram of selecting a second virtual prop through a drag operation according to an exemplary embodiment of this application.

FIG. 10 is a diagram of a preview window according to an exemplary embodiment of this application.

FIG. 11A is a diagram of displaying a preview window through a touch and hold operation according to an exemplary embodiment of this application.

FIG. 11B is a diagram of displaying a preview window through a trigger operation according to an exemplary embodiment of this application.

FIG. 12 is a diagram of a prop buff according to an exemplary embodiment of this application.

FIG. 13 is a schematic flowchart of another game processing method according to an exemplary embodiment of this application.

FIG. 14 is a diagram of presenting a level option in a prop presentation window according to an exemplary embodiment of this application.

FIG. 15A is a diagram of outputting a feedback message according to an exemplary embodiment of this application.

FIG. 15B is a diagram of outputting confirmation prompt information according to an exemplary embodiment of this application.

FIG. 16 is a diagram of replacing or canceling a second virtual prop according to an exemplary embodiment of this application.

FIG. 17 is a diagram of viewing a historical inheritance record according to an exemplary embodiment of this application.

FIG. 18 is a diagram of a background procedure of a game processing method according to an exemplary embodiment of this application.

FIG. 19 is a diagram of a structure of a game processing apparatus according to an exemplary embodiment of this application.

FIG. 20 is a diagram of a structure of a computer device according to an exemplary embodiment of this application.

### DESCRIPTION OF EMBODIMENTS

In embodiments of this application, a game processing solution is provided, and specifically, a solution of transferring a special effect between virtual props in a video game to promote a gamer to pursue a new prop is provided. The following briefly describes a video game and a virtual prop involved in embodiments of this application.

The video game (briefly referred to as a game) is a game that appears with a computer and that is controlled by a computer program. A gamer is a user or an object controlling the video game. The gamer plays the video game by playing a virtual character in the video game. The virtual character is a digital game character used by the gamer to represent the gamer in the video game. The virtual character is an image of various virtual persons and virtual objects interacting with each other in the video game, or a movable object (such as a virtual person, a virtual animal, or an animation character) in the video game. For example, the movable object is a virtual person, a virtual animal, or the like displayed in any virtual scene (for example, the virtual scene may be a simulated environment, a semi-simulated and semi-fictional virtual environment, or a pure-fictional virtual environment for the real world; and the virtual scene may be any one of a two-dimensional virtual scene, a 2.5-dimensional virtual scene, or a three-dimensional virtual scene) provided by the video game. In the video game, the gamer may control the virtual character to perform any operation that the gamer wants to perform, for example, control the virtual character to jump, run, or crouch.

Video games may be classified into different game types according to different classification dimensions. In some embodiments, the video games may be classified into a mobile phone game, a client game, a browser game, cloud gaming, a virtual reality game, an augmented reality game, and the like according to game running modes. 1. The client game is referred to as a client-based game, and is a game running on an intelligent computer. The client game can be operated only after an installation package of the game is downloaded and installed in the intelligent computer (such as a personal computer). 2. The browser game is referred to as a world wide web (Web) game or a browser-based game, and is an online network game controlled by opening a game web page in a browser. 3. The mobile phone game is briefly referred to as a mobile game, and is a game running on a smartphone. The mobile phone game can be operated on the smartphone only after an installation package of the mobile phone game is downloaded and installed on the smartphone. 4. The augmented reality game is a game combining virtuality and reality. Compared with the virtual reality game, the augmented reality game provides a game scene that is usually superimposed in a real physical environment in which a gamer is currently located. 5. The virtual reality game may include a game controlled by wearing a wearable device (for example, a virtual reality helmet). The virtual reality game usually simulates a completely virtual game scene, and the game scene may have no relation to a real physical environment in which a gamer is currently located. In addition, by wearing the wearable device, the gamer is made to appear to be in a real game scene. The cloud gaming is referred to as gaming on demand, and is an online game technology based on a cloud computing technology. In a running mode of the cloud gaming, the cloud gaming is not run in a terminal device (such as a smartphone, a personal computer, or a wearable device) of a gamer, but is run in a cloud server. The cloud server renders a game scene into an audio and video stream, and the cloud server transmits the rendered audio and video stream to the terminal device through a network. In this way, the terminal device directly plays the audio and video stream.

In some embodiments, the video games may be classified into a role-playing game (RPG), a shooting game, an action game (ACT), and the like according to game play methods. 1. The action game is a game in which a gamer controls a game character and uses various manners to destroy enemies or ensure to clear the game. The action game usually does not intend to pursue a story plot, is designed to face a common gamer, and is a popular game with the objective of pure entertainment. The shooting game includes a first-person shooting (FPS) game, a third-person shooting (TPS) game, a multiplayer online battle arena (MOBA) game, or the like. The first-person shooting game is a shooting game that a gamer can play from a first-person perspective. A picture of a virtual scene in the game is a picture of observing the virtual scene from a perspective of a first virtual object. The third-person shooting game is a shooting game that a gamer can play from a third-person perspective. A picture of a virtual scene in the game is a picture of observing the virtual scene from the third-person perspective. The multiplayer online battle arena is an arena game in which a plurality of gamers can form the same game group or game camp online to make an arena. 3. The role-playing game is a game with a complete story in which a gamer plays at least one game character (or referred to as a game object, a virtual object, or the like) in the game. In a massively multiplayer online role-playing game, a gamer may complete a specified game task in the game, purchase a sold virtual article, or the like to improve a game capability (such as a confrontation capability or a regeneration capability) of a game character, to better interact with a game character controlled by another gamer in a virtual network space.

The foregoing descriptions are merely two exemplary game classification manners. For ease of description, in embodiments of this application, an example in which a video game is a role-playing game (RPG) and the role-playing game is a mobile game (the mobile game may alternatively be a cloud game or a local game) is used below to describe embodiments of this application.

The virtual prop is a digital game prop configured for decorating a virtual character. In a video game, a game capability of a virtual character is improved by using a virtual prop. The virtual prop is referred to as a virtual item or virtual equipment (equipment for short), and includes but is not limited to virtual clothes, a virtual hat, a virtual ring, virtual armor, and the like. When a gamer decorates a virtual character with a virtual prop, a game capability of the virtual prop may be improved (for example, a defense capability is improved) for the virtual character. Decorating a virtual character with a virtual prop is a process in which the virtual prop covers a surface region of the virtual character with a texture map. For example, if the virtual prop is virtual clothes, decorating a virtual character with virtual clothes means covering an upper body region of a surface of the virtual character with a virtual hat of a texture map, visually, dressing/decorating the upper body of the virtual character with the virtual clothes.

Further, the virtual prop has a prop level (or referred to as prop quality). Prop levels of virtual props may be classified based on obtaining difficulty and cultivation difficulty of the virtual props, and represent the obtaining or cultivation difficulty of the virtual props. For example, higher obtaining difficulty indicates a higher prop level of a virtual prop; otherwise, lower obtaining difficulty indicates a lower prop level of a virtual prop. For another example, higher cultivation difficulty indicates a higher prop level of a virtual prop; otherwise, lower cultivation difficulty indicates a lower prop level of a virtual prop. For two virtual props of the same prop type, a higher prop level indicates a stronger prop capability of a virtual prop. On the contrary, a lower prop level indicates a weaker prop capability of a virtual prop. A prop capability (or referred to as a game capability) of a virtual prop may be embodied by a prop attribute (such as a life attribute or a magic attribute), an upper limit of skill strength of a game skill (such as a defense skill, an attack skill, or a flash skill), or the like of the virtual prop. For example, a stronger prop capability of a virtual prop indicates a higher upper limit of skill strength of a game skill of the virtual prop, that is, the game skill of the virtual prop can reach higher skill strength. For example, prop levels of virtual props of the same prop type are distinguished based on colors. Colors of corresponding virtual props are sequentially green, blue, purple, orange, and gold in ascending order of prop levels. In other words, the prop level of the gold virtual prop is higher than the prop level of the orange virtual prop, the prop level of the orange virtual prop is higher than the prop level of the purple virtual prop, the prop level of the purple virtual prop is higher than the prop level of the blue virtual prop, and the prop level of the blue virtual prop is higher than the prop level of the green virtual prop.

Further, a virtual prop may have at least one type of game skill. A quantity of game skills of a virtual prop is not limited in embodiments of this application. In addition, skill strength of a game skill of a virtual prop may be continuously improved as a cultivation target is achieved. Specifically, skill strength of a game skill is cultivated by collecting a special effect resource (or referred to as a special effect entry) corresponding to the game skill by a gamer. For example, a gamer obtains a special effect resource corresponding to a game skill by executing a game task provided by a video game, directly purchasing a virtual commodity provided by a video game, or the like. As a quantity of special effect resources increases, various cultivation targets included in a cultivation line that is about a game skill and that is provided by a video game are gradually reached (for example, when the quantity of special effect resources is 1, the game skill reaches a cultivation target 1, and when the quantity of special effect resources is 2, the game skill reaches a cultivation target 2), to obtain skill strength corresponding to the reached cultivation targets. With improvement of skill strength of a game skill, a prop capability of a virtual prop to which the game skill belongs is improved. In this way, when the gamer decorates a virtual character with the virtual prop and uses a prop skill (such as a confrontation capability or a defense capability) of the virtual prop, corresponding skill strength can be effectively improved, thereby helping the gamer better complete the game, and improving game experience. A higher prop level of a virtual prop indicates a higher upper limit of skill strength of a game skill of the virtual prop and a higher quantity of special effect resources required to cultivate higher skill strength of the game skill. In other words, an upper limit of the quantity of special effect resources that can be collected for the game skill is positively correlated with the prop level of the virtual prop. For example, a higher prop level of the virtual prop indicates a higher upper limit of the quantity of special effect resources that can be collected for the game skill.

It can be learned from the foregoing descriptions that a special effect resource corresponding to a game skill of a virtual prop is an evaluation factor that directly affects quality of the virtual prop. A larger quantity of special effect resources indicates higher skill strength of a game skill corresponding to the special effect resources and a stronger prop capability of a virtual prop to which the game skill belongs.

During actual application, the gamer may have a plurality of virtual props of the same prop type. In this case, the gamer needs to weight how to cultivate the plurality of virtual props. For example, the gamer has a purple virtual prop, and the purple virtual prop has cultivated (or has) a skill special effect set (for example, special effect resources corresponding to one or more game skills). When obtaining a higher-quality gold virtual prop, the gamer needs to cultivate the gold virtual prop from the very beginning. In this way, because a previously cultivated virtual prop (for example, the purple virtual prop) needs to be abandoned when a higher-quality prop is obtained, although the gamer obtains the higher-quality virtual prop, a prop capability of the higher-quality virtual prop is weaker than a prop capability of the cultivated low-quality virtual prop because the higher-quality virtual prop has not been cultivated yet.

To overcome defects such as solidification and fragmentation of conventional prop cultivation, a game processing solution provided in embodiments of this application specifically provides an equipment inheritance solution. Equipment inheritance or prop inheritance is a process of losslessly transferring a skill special effect set of one virtual prop to another virtual prop of the same prop type. For example, a virtual prop 1 and a virtual prop 2 are both damage-type props, and the virtual prop 1 has a skill special effect set. Therefore, the skill special effect set of the virtual prop 1 may be transferred to the virtual prop 2. In this case, the virtual prop 1 does not have the skill special effect set, and the virtual prop 2 has the skill special effect set. In the solution, an equipment inheritance system (or referred to as a prop transfer system) is newly added to a video game. The equipment inheritance system is configured to losslessly transfer a skill special effect set of one virtual prop to another virtual prop of the same prop type, thereby improving flexibility of prop cultivation. General logic of the equipment inheritance solution provided in embodiments of this application may include: When having an equipment inheritance requirement, a gamer may select a first virtual prop that is to receive a special effect. In this case, the first virtual prop obtained by a virtual character in a virtual scene is displayed in a terminal device of the gamer. The virtual character is associated with at least one candidate virtual prop, and a prop type of the candidate virtual prop is the same as a prop type of the first virtual prop. Then, the gamer may select a second virtual prop from which a special effect is to be transferred from the at least one candidate virtual prop associated with the virtual character, and a computer device receives a selection operation of the gamer on the second virtual prop. The second virtual prop has a skill special effect set (including a special effect resource corresponding to a game skill), that is, the second virtual prop has cultivated a special effect resource (or a special effect entry) corresponding to the game skill. The computer device transfers the skill special effect set of the second virtual prop to the first virtual prop based on the second virtual prop autonomously selected by the gamer. After the skill special effect is transferred, the first virtual prop has the skill special effect set of the second virtual prop. Therefore, after the virtual character is equipped with the first virtual prop, a game skill of the first virtual prop used in the virtual scene has skill strength that matches a special effect resource corresponding to the game skill (for example, a larger quantity of special effect resources indicates stronger skill strength).

It can be learned that in embodiments of this application, the skill special effect set can be transferred from the second virtual prop to the first virtual prop through equipment inheritance, and the skill special effect set is an important factor of developing or cultivating skill strength of a game skill of a virtual prop. By improving flexibility of inheritance of a skill special effect set between virtual props of the same prop type, the gamer may be promoted to pursue a virtual prop of better quality without pressure, and the gamer is also prevented from starting cultivation from the very beginning when obtaining a higher-quality virtual prop, thereby improving a cultivation speed and efficiency of a virtual prop.

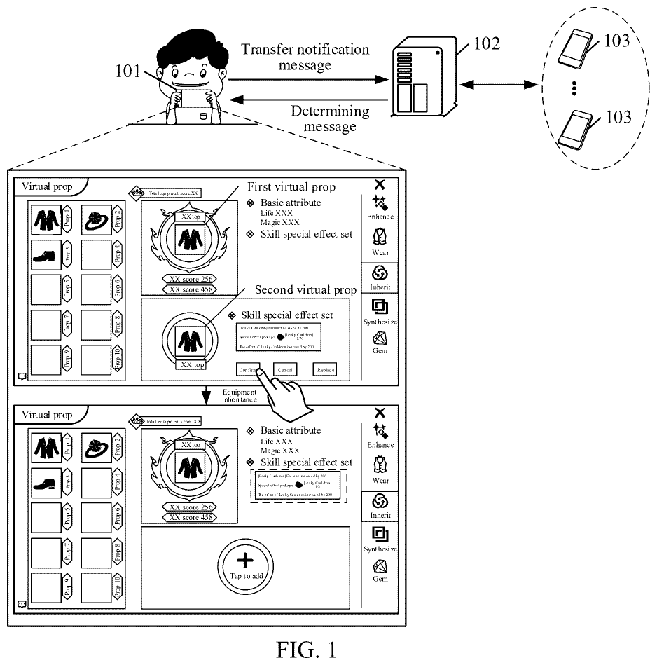

To better understand the foregoing game processing solution, the following describes the game processing solution in embodiments of this application with reference to an actual game scene. Refer to FIG. 1. FIG. 1 is a diagram of an architecture of a game processing system according to an exemplary embodiment of this application. As shown in FIG. 1, the system includes a terminal device and a server. Types and quantities of terminal devices and servers are not limited in embodiments of this application. For example, when a video game is a massively multiplayer online role-playing game, there may be a plurality of terminal devices, which are respectively devices used by gamers participating in the video game. This embodiment of this application is described by using an example in which any one of a plurality of gamers controls the video game.

A terminal device 101 may be a control device used by any gamer participating in the video game. A terminal device 102 is a terminal device used by another gamer in the same virtual scene (or game room) provided by the video game as the any gamer holding the terminal device 101. Each gamer accesses, by using a terminal device used by the gamer, the same virtual scene provided by the video game to perform real-time game interaction, thereby improving fun and authenticity of the game. The terminal device (for example, the terminal device 101 and the terminal device 102) may include but is not limited to a smartphone (for example, an Android mobile phone or an iOS mobile phone), a tablet computer, a portable personal computer, a mobile Internet device (MID), a smart television, an in-vehicle device, a head-mounted device, a game controller, a remote control, an arcade machine, or another smart device with a touchscreen. Specifically, a game application program providing a video game is deployed in the terminal device 101 and the terminal device 102, and a gamer specifically starts the video game and plays the video game by using the game application program.

A server 103 may be a background server of the terminal device 101 and the terminal device 102, and is configured to interact with the terminal device 101 and the terminal device 102, to provide computation and application service support for the terminal device 101 and the terminal device 102. The server 103 may be an independent physical server, or may be a server cluster or distributed system including a plurality of physical servers. When the video game is cloud gaming, the server 103 is a cloud server or a cloud-based server. In this implementation, the video game may forward, to the cloud server, data (for example, an input instruction or a signal) transmitted by the terminal device, and the cloud server is responsible for rendering a game picture based on the data, compressing the rendered game picture, and transmitting, through a network, the game picture to the terminal device used by the gamer. In this case, the terminal device performs only a game picture display operation. In this running mode of the cloud gaming, the terminal device used by the gamer does not need to have powerful graphics computing and data processing capabilities, and only needs to have a basic streaming media playback capability (for example, a game picture display capability), a human-computer interaction capability (a capability of obtaining a gamer input operation), and a data transmission capability (for example, a capability of transmitting an instruction to the cloud server).

The terminal device (for example, the terminal device 101 and the terminal device 102) and the server 103 may be directly or indirectly connected through wired or wireless communication. A mode of the connection between the terminal device and the server is not limited in embodiments of this application. The game processing solution provided in embodiments of this application may be performed by the foregoing terminal device or server, or may be jointly performed by the terminal device and the server, specifically, by a game application deployed in a terminal device and a server corresponding to the game application. An example in which a terminal device and a server jointly perform a game data processing solution and a video game is a client game is used to describe a processing procedure of the solution.

During specific implementation, when a gamer wants to control the video game, the gamer may use a terminal device of the gamer to open and start a game application deployed in the terminal device. In this case, the terminal device transmits a data obtaining request to a server. The data obtaining request is configured for requesting the server to return resource data related to the video game (for example, historical game data of the gamer and game data related to the video game). After receiving the data obtaining request, the server returns the corresponding resource data to the terminal device in response to the data obtaining request. After receiving the resource data returned by the server, the terminal device renders and displays a game picture based on the resource data, to output a game interface of the video game on a display screen of the terminal device. The game interface displayed on the terminal device may be any access interface that the gamer has an access right to. For example, if the gamer wants to perform equipment inheritance, the game interface may be a virtual prop interface, and the gamer may select a first virtual prop that is to receive a special effect in the virtual prop interface. Further, a virtual character controlled by the gamer in the video game is associated with at least one candidate virtual prop that has been cultivated, the gamer selects a second virtual prop from which a special effect is to be transferred from the at least one candidate virtual prop, and the second virtual prop has a skill special effect set that has been cultivated. If the gamer triggers to transfer the skill special effect set of the second virtual prop to the first virtual prop in the terminal device, the terminal device may generate a transfer notification message, and transmit the transfer notification message to the server, so that a server side performs a related operation about equipment inheritance (for example, determines a level relationship between the first virtual prop and the second virtual prop, or implements reallocation of the skill special effect set) in response to the transfer notification message. In some embodiments, the server may further transmit a determining message to the terminal device (for example, the determining message includes interface data obtained after a skill special effect is transferred) after re-allocating the skill special effect set of the second virtual prop. In this way, the terminal device associatively displays the first virtual prop and the skill special effect set in an interface based on the determining message, so that the gamer intuitively senses that the skill special effect set has been transferred from the second virtual prop to the first virtual prop.

According to different running modes of the video game, the processing procedure of the game processing solution provided in embodiments of this application is different from the foregoing description. For example, when the video game is the cloud gaming, the terminal device is only responsible for playing or displaying a game picture, and the cloud server renders the game picture. 2. As described above, a virtual prop has a prop level. A level relationship between prop levels of the first virtual prop and the second virtual prop that perform equipment inheritance is not limited in embodiments of this application. For example, the prop level of the first virtual prop may be higher than the prop level of the second virtual prop. For another example, the prop level of the first virtual prop may be equal to the prop level of the second virtual prop. For another example, the prop level of the first virtual prop may be lower than the prop level of the second virtual prop. For ease of description, the following takes an example in which the prop level of the first virtual prop is higher than the prop level of the second virtual prop. In other words, a skill special effect set of a low-quality virtual prop can be transferred to a high-quality virtual prop. In this way, a gamer can pursue a prop level smoothly without any hindrance, and every time the gamer obtains a high-quality prop, the gamer does not need to worry about whether to cultivate a high-quality prop or retain a cultivated low-quality prop. This can encourage the gamer to use an equipment inheritance function to transfer a skill special effect set of a low-quality prop to a high-quality prop, thereby promoting the gamer to pursue a prop capability of the higher-quality prop and retain a cultivated skill special effect set of the low-quality prop, providing the gamer with linear cultivation experience in prop cultivation, greatly improving game experience of the gamer. 3. In embodiments of this application, relevant data collection and processing need to be in strict accordance with requirements of relevant laws and regulations, personal information acquisition requires the knowledge or consent of an individual subject (or has legal basis for information acquisition), and subsequent data usage and processing behaviors are carried out within the scope of authorization of laws and regulations and the personal information subject. For example, when embodiments of this application are applied to a specific product or technology, for example, when equipment inheritance is performed between the first virtual prop and the second virtual prop, permission or consent of a gamer holding the first virtual prop and the second virtual prop needs to be obtained, and collection, use, and processing of relevant data need to comply with relevant laws, regulations, and standards of relevant regions.

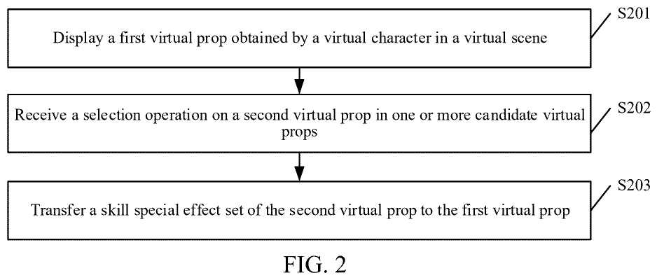

Based on the relevant description of the foregoing game processing solution, embodiments of this application provide a more detailed game processing method in combination with the accompanying drawings. The method may be performed by the terminal device mentioned above, or may be performed by a game application deployed in the terminal device. For ease of description, an embodiment of this application is described by using an example in which the terminal device performs the game processing method. As shown in FIG. 2, the game processing method may include the following operations S201 to S203.

S201: Display a first virtual prop obtained by a virtual character in a virtual scene.

The first virtual prop may be any virtual prop obtained by the virtual character in the virtual scene. The virtual scene may be any scene provided by a video game for the virtual character, and includes but is not limited to a game scene in which the virtual character participates in the game in a game room, an equipment upgrade scene in which the virtual character upgrades equipment, a login scene in which a gamer obtains a reward when logging in to the video game, and the like. Further, only after the virtual character is equipped with a virtual prop (for example, the virtual character wears a virtual top), a game skill of the virtual prop can be released when the virtual character uses the virtual prop in the virtual scene. Based on this, in this embodiment of this application, the first virtual prop selected to receive a special effect is a virtual prop that is associated with the virtual character and that the virtual character has been equipped with. In other words, the first virtual prop to be inherited (that is, to receive a special effect) is a virtual prop that the virtual character has been equipped with. In this way, after inheriting the first virtual prop, a gamer may directly use, in the virtual scene, a game skill of corresponding skill strength obtained after the first virtual prop is inherited, thereby implementing rapid game skill use, and improving game experience of the gamer.

In this embodiment of this application, the selected first virtual prop can be displayed in a virtual prop interface of the virtual character provided by the video game. The virtual prop interface may be a main interface of an equipment inheritance system (or referred to as a prop inheritance system) that is set in the video game, so as to implement, in the main interface, equipment inheritance between different virtual props associated with the virtual character. This embodiment of this application does not limit a triggering manner or path of triggering to display the virtual prop interface of the virtual character in the video game. The following provides two exemplary manners of triggering to display the virtual prop interface of the virtual character, and displaying, in the virtual prop interface, the first virtual prop obtained by the virtual character in the virtual scene.

By using a second access component configured to access a prop inheritance system, the virtual prop interface of the virtual character is triggered to be displayed, and the first virtual prop that is to receive a special effect is displayed in the virtual prop interface. In other words, when the gamer has an equipment inheritance requirement, the gamer may actively trigger the second access component configured to access the prop inheritance system in the video game, to trigger to display the virtual prop interface of the virtual character, thereby satisfying a game requirement that the gamer actively initiates equipment inheritance.

During specific implementation, when the gamer has a requirement for equipment inheritance of a virtual prop, the gamer uses and opens a game application program in a terminal device of the gamer, to start a video game provided by the game application program, so as to display a game access interface of the video game on a display screen of the terminal device. The game access interface may be understood as a main interface of the video game. The main interface includes access entries of various game systems (for example, a game setting system, a game room system, and an equipment system (for example, the equipment system is embedded with a subsystem, for example, the subsystem is an equipment inheritance system configured to implement equipment inheritance)) provided by the video game, so that each game system can be quickly entered from the game access interface to perform a corresponding operation.

In this embodiment of this application, the game access interface of the video game includes a first access component configured to access a virtual prop of the virtual character (that is, a first access component configured to access the equipment system). When the gamer performs a trigger operation on the first access component in the game access interface, in response to the trigger operation on the first access component, the terminal device may enter the equipment system provided by the video game, and display a virtual prop interface of the equipment system. Considering that the equipment system is related to the virtual character controlled by the gamer, the virtual prop interface of the equipment system is also referred to as the virtual prop interface of the virtual character. The equipment system may be embedded with subsystems having different functions related to virtual props. For example, the subsystem includes but is not limited to a prop enhancement system, a prop backpack system, a prop inheritance system (that is, the equipment inheritance system mentioned above), and an equipment synthesis system. Therefore, the virtual prop interface of the equipment system includes access entries corresponding to subsystems having different functions. For example, the virtual prop interface includes the second access component configured to access the prop inheritance system (the component includes an access entry for accessing the prop inheritance system). In this way, if the second access component in the virtual prop interface is in a selected state (which is represented as that a color depth (or brightness) of the second access component is greater than a color depth (or brightness) of another access component, or transparency of the second access component is lower than transparency of another access component, or the like), the gamer wants to access the prop inheritance system corresponding to the second access component. In this case, interface content of the prop inheritance system is displayed in the virtual prop interface, and specifically, the first virtual prop obtained by the virtual character in the virtual scene is displayed in the virtual prop interface.

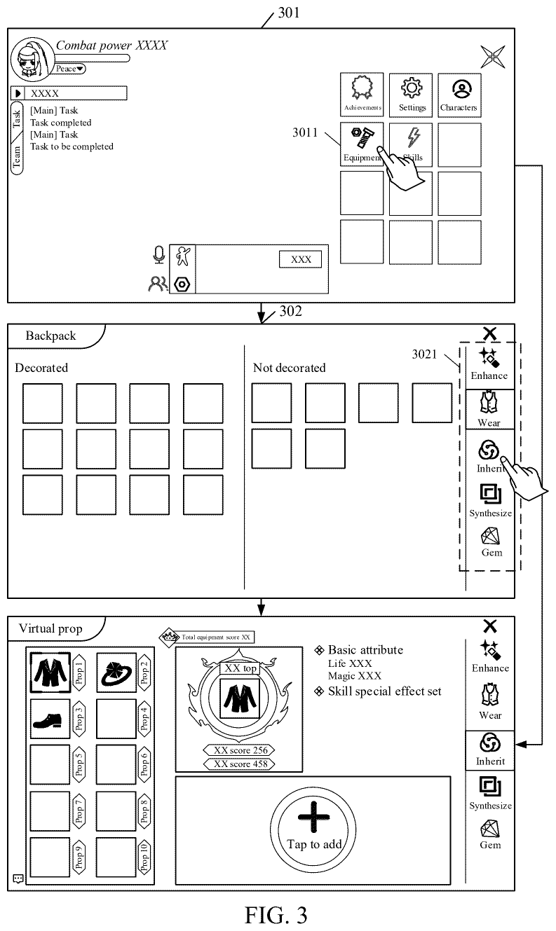

For an exemplary schematic flowchart of triggering to display a virtual prop interface of a virtual character by triggering a second access component for accessing a prop inheritance system, refer to FIG. 3. As shown in FIG. 3, after a gamer uses and opens a game application program deployed in a terminal device, a game access interface 301 of a video game is displayed on a display screen of the terminal device. The game access interface 301 includes entries configured to access different game systems in the video game, for example, includes a first access component 3011 configured to access an equipment system in the video game. When the gamer has a requirement of operating a virtual prop, for example, the gamer wants to replace equipment of a virtual character, for another example, the gamer wants to update or inherit the virtual prop, the gamer may perform a trigger operation on the first access component 3011 in the game access interface 301. In this case, the terminal device (specifically, the game application program or the video game deployed in the terminal device) displays a virtual prop interface 302 of the equipment system in response to the trigger operation on the first access component 3011. Considering that all virtual props displayed in the virtual prop interface 302 are related to the virtual character, the virtual prop interface may also be referred to as a virtual prop interface 302 of the virtual character. The virtual prop interface 302 includes an option region 3021. The option region 3021 is configured for displaying an access entry corresponding to each subsystem in the equipment system. For example, the option region 3021 includes an “enhancement option” configured to access a prop enhancement system, a “wear option” configured to access a prop backpack system, a “second access component” configured to access a prop inheritance system, and the like.

The gamer performs a trigger operation on a corresponding option in the virtual prop interface 302 according to an operation requirement of the gamer for a virtual prop, the option on which the trigger operation is performed is set to a selected state, and corresponding interface content is displayed in the virtual prop interface 302 based on the triggered option, so that the gamer can edit the corresponding interface content in the virtual prop interface. For example, continue to refer to FIG. 3. Assuming that the wear option in the option region 3021 is selected by default when the virtual prop interface 302 is triggered to be displayed, the wear option is set to a selected state, and interface content corresponding to the “wear option” is displayed in the virtual prop interface 302 (for example, a virtual prop that the virtual character has been equipped with and a virtual prop that the virtual character is not equipped with are displayed in the virtual prop interface in a partitioned manner). In this implementation, if the gamer has a requirement for equipment inheritance, the gamer may perform a trigger operation on the second access component in the virtual prop interface 302. In this case, the second access component may be set to a selected state, the selected state of the wear option is canceled, and interface content related to the second access component is displayed in the virtual prop interface.

Further, when the second access component is in the selected state, the interface content that is related to the second access component and that is displayed in the virtual prop interface includes a prop selection region. The prop selection region is configured for displaying a virtual prop that the virtual character has been equipped with. Therefore, after a selected first virtual prop is determined from the prop selection region, the selected first virtual prop may be displayed in the virtual prop interface, that is, the first virtual prop obtained by the virtual character in a virtual scene is displayed in the virtual prop interface. A manner of determining the first virtual prop displayed in the virtual prop interface may include at least the following: 1. A virtual prop selected by default in the prop selection region is used as the first virtual prop. In other words, when the second access component is triggered, one virtual prop may be selected by default in the prop selection region in the virtual prop interface. In this case, if the gamer does not replace the selected virtual prop, the virtual prop selected by default is used as the first virtual prop. A selection rule of the selected virtual prop in the prop selection region includes but is not limited to: selecting a virtual prop at a designated position (for example, a virtual prop at a first display position) in the prop selection region by default; or selecting a virtual prop of a prop type in the prop selection region by default (for example, prop types included in the prop selection region are a clothing type, a jewelry type, and a shoe type, a descending order of priorities is clothing type→jewelry type→shoe type, and therefore one virtual prop is selected by default from at least one virtual prop of the jewelry type when the prop selection region includes only virtual props of the jewelry type and the shoe type); or selecting a virtual prop in the prop selection region by default according to a prop inheritance policy (if the prop inheritance policy indicates that the first virtual prop is a virtual prop whose prop level is greater than a level threshold, only one virtual prop can be selected by default from at least one virtual prop whose prop level is greater than the level threshold in the prop selection region), or the like.

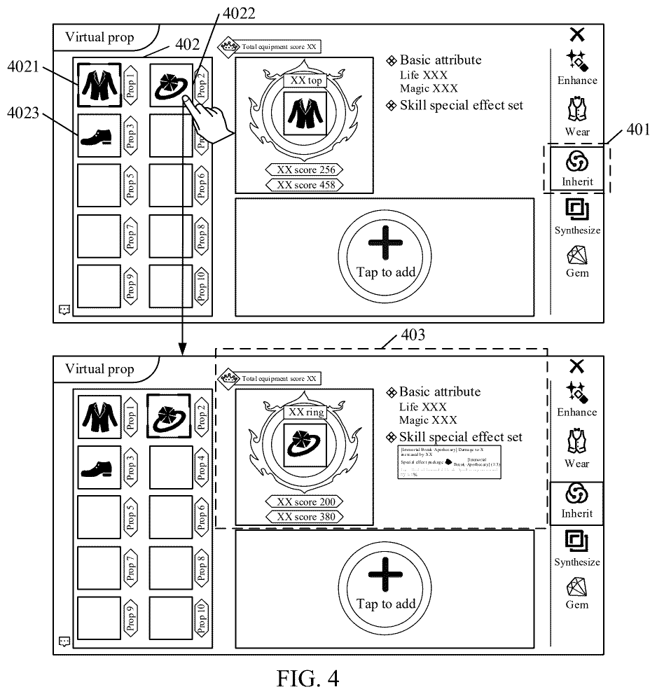

2. The gamer may perform a prop selection operation in the prop selection region in the virtual prop interface. In this case, in response to the prop selection operation received in the prop selection region, the terminal device uses a selected virtual prop as the first virtual prop that is to receive a special effect. In other words, in this embodiment of this application, the gamer can personally select, from the prop selection region according to an equipment inheritance requirement of the gamer, the first virtual prop that is to receive a special effect, to grant selection permission of the gamer in an equipment inheritance scenario, thereby satisfying a requirement of the gamer to customize the first virtual prop. For example, for an interface diagram of selecting a first virtual prop from a prop selection region based on a prop selection operation, refer to FIG. 4. As shown in FIG. 4, when a second access component 401 in a virtual prop interface is in a selected state, a gamer has a requirement of performing equipment inheritance. In this case, at least one virtual prop that a virtual character has been equipped with is displayed in a prop selection region 402 included in the virtual prop interface, for example, a virtual prop 4021, a virtual prop 4022, and a virtual prop 4023. In addition, a virtual prop selected by default in the prop selection region 402 is the virtual prop 4021, and if a gamer wants to use the virtual prop 4021 as the first virtual prop, the gamer does not need to perform a prop selection operation in the prop selection region 402. Otherwise, if the gamer wants to use a virtual prop (such as the virtual prop 4022) other than the virtual prop 4021 in the prop selection region 402 as the first virtual prop, the gamer may perform a prop selection operation in the prop selection region 402 to select the virtual prop 4022.

In this embodiment of this application, the virtual prop selected by default can be used as the first virtual prop, and the gamer does not need to select the first virtual prop again, thereby improving convenience of determining the first virtual prop. In addition, in this embodiment of this application, the gamer can actively select the first virtual prop in the virtual prop interface according to a prop inheritance requirement of the gamer, thereby improving flexibility of determining the first virtual prop, and satisfying a requirement of the gamer to customize the first virtual prop.

The virtual prop interface of the virtual character further includes a first display region, and the first display region is configured for presenting prop information of the first virtual prop. Prop information of a virtual prop is some data that is related to the virtual prop and that facilitates the gamer to master a prop capability of the virtual prop, and includes but is not limited to a prop identifier of the virtual prop (such as a number or an icon configured for uniquely identifying the virtual prop), attribute information of the virtual prop (such as a hit point or a magic point), and a skill special effect set of the virtual prop (such as a quantity of special effect entries corresponding to each game skill that has been cultivated by the virtual prop). In this way, after the first virtual prop is selected from the virtual prop selection region, the prop information of the first virtual prop may be displayed in the first display region of the virtual prop interface, that is, the prop information of the first virtual prop obtained by the virtual character in the virtual scene is displayed in the first display region, so that the gamer can intuitively sense the selected first virtual prop from the virtual prop interface. For a diagram of the first display region displayed in the virtual prop interface, continue to refer to FIG. 4. The virtual prop interface shown in FIG. 4 includes a first display region 403. When a virtual prop (such as the virtual prop 4022) in the prop selection region 402 in the virtual prop interface is in a selected state, prop information of the virtual prop 4022 may be displayed in the first display region 403 together.

When the virtual character obtains a new target virtual prop, the virtual prop interface of the virtual character is triggered to be displayed from a prop prompt window, and the first virtual prop that is to receive a special effect is displayed in the virtual prop interface. In this case, the target virtual prop is used as the first virtual prop by default (or the gamer may reselect a new virtual prop in the virtual prop interface as the first virtual prop). In other words, in this embodiment of this application, the virtual prop interface of the virtual character can be triggered to be displayed by using the prop prompt window, and the first virtual prop that is to receive a special effect can be displayed in the virtual prop interface. The prop prompt window is a window that is outputted to the gamer when the virtual character obtains a new target virtual prop (for example, a virtual prop of any prop type), so that the gamer intuitively senses the obtained new target virtual prop. In other words, when the gamer obtains the new target virtual prop, in this embodiment of this application, the virtual prop interface of the first virtual prop can be directly triggered to be displayed in the prop prompt window displaying the target virtual prop, thereby shortening a path for the gamer to open the virtual prop interface, implementing a simply operation and a quick speed, and improving game experience of the gamer.

During specific implementation, in a process of controlling the video game, the gamer may obtain a new target virtual prop issued by the video game (for example, obtain the new target virtual prop by completing a game task, or obtain the new target virtual prop by purchasing a game resource, or obtain the new target virtual prop through equipment synthesis). In this case, the video game displays or outputs the prop prompt window to prompt the gamer that the new target virtual prop has been obtained. The prop prompt window includes the new target virtual prop obtained by the virtual character in the virtual scene. The prop prompt window further includes a decoration option. When the decoration option in the prop prompt window is triggered, the gamer wants to decorate the virtual character with the target virtual prop. In this case, the terminal device decorates the virtual character with the target virtual prop in response to an operation of selecting the decoration option in the prop prompt window by the gamer, to implement rapid decoration of a virtual prop. For example, if the virtual character has been equipped with a virtual prop whose prop type is the same as that of the target virtual prop, the virtual prop that the virtual character has been equipped with and whose prop type is the same as that of the target virtual prop is replaced with the target virtual prop. The prop prompt window further includes a prop inheritance option. When the prop inheritance option in the prop prompt window is selected, the gamer wants to directly use the newly obtained target virtual prop as the first virtual prop, the virtual prop interface of the virtual character is displayed, and the first virtual prop obtained by the virtual character in the virtual scene is displayed in the virtual prop interface. In this case, the first virtual prop is the target virtual prop.

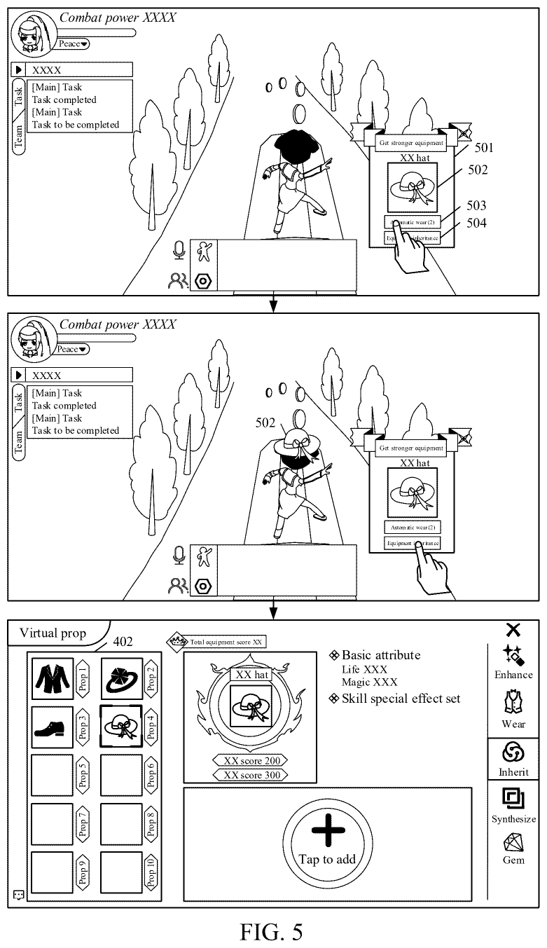

For an exemplary diagram of triggering to display the virtual prop interface by using the prop prompt window, and displaying the first virtual prop in the virtual prop interface, refer to FIG. 5. As shown in FIG. 5, assuming that a gamer obtains a new target virtual prop (for example, the target virtual prop is a virtual hat) when controlling a virtual character to play a game in a game scene, a prop prompt window 501 is outputted. The prop prompt window 501 includes a new target virtual prop 502, a decoration option 503, and a prop inheritance option 504. When the gamer performs a selection operation on the decoration option 503 in the prop prompt window 501, the terminal device may decorate the virtual character with the target virtual prop in response to the selection operation on the decoration option 503. For example, the target virtual prop in FIG. 5 is the virtual hat. When the selection operation is performed on the decoration option 503, and it is detected that the virtual character is not equipped with a hat currently, the virtual hat is directly added to a head position of the virtual character, so that the virtual character wears the virtual hat from a visual effect of the gamer. Further, if the gamer wants to directly use the target virtual prop that the virtual character has been equipped with as a first virtual prop in equipment inheritance, the gamer may continue to perform a selection operation on the prop inheritance option 504 in the prop prompt window 501. In this case, a virtual prop interface of the virtual character may be triggered to be displayed; and a new target virtual character is added in a prop selection region in the virtual prop interface, and prop information of the target virtual prop is displayed in a first display region in the virtual prop interface, so as to intuitively inform the gamer that the target virtual prop has been currently selected as the first virtual prop.

FIG. 5 merely shows a display manner of an exemplary prop prompt window and options (such as the decoration option and the prop inheritance option) provided in this application, and does not limit this embodiment of this application.

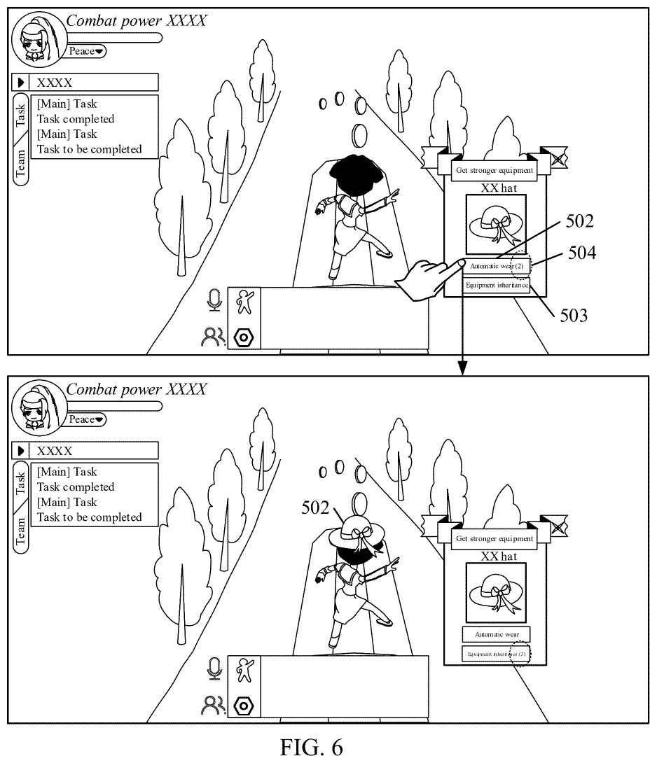

For example, considering that the first virtual prop capable of equipment inheritance is a virtual prop that the virtual character has been equipped with, when the decoration option in the prop prompt window is not selected, the prop inheritance option can be set to an unselectable state; and the prop inheritance option can be set to a selectable state only when the decoration option is selected. A status of the prop inheritance option is dynamically set according to a situation of whether the virtual character is equipped with the target virtual prop, helping the gamer intuitively understand a situation of whether the target virtual prop is capable of equipment inheritance, thereby avoiding a misoperation on the prop inheritance option when the virtual character is not equipped with the target virtual prop. As shown in FIG. 6, if a decoration option 502 in a prop prompt window is not selected, a prop inheritance option 503 is in an unselectable state (for example, the prop inheritance option 503 is shown in grayscale); and when a selection operation is performed on the decoration option 502, the prop inheritance option 503 is switched from the unselectable state to a selectable state.

For example, display of at least one of the prop prompt window, the decoration option in the prop prompt window, and the prop inheritance option in the prop prompt window is limited by time. For example, assuming that display duration of the prop prompt window is set to 10 seconds, once the display duration of the prop prompt window reaches 10 seconds, the prop prompt window is closed regardless of whether the gamer performs any operation on the prop prompt window. For example, assuming that display duration of the decoration option is set to 5 seconds (as shown in FIG. 6), and remaining duration 504 is displayed in a countdown form adjacent to the decoration option 502), the prop prompt window is automatically closed when the display duration of the decoration option in the prop prompt window is 5 seconds; and if the gamer performs a selection operation on the decoration option within 5 seconds, a timer of the decoration option is closed, and a timer of the prop inheritance option in the prop prompt window is started. Similarly, assuming that display duration of the prop inheritance option is set to 3 seconds, the prop prompt window is automatically closed when the display duration of the prop inheritance option in the prop prompt window is 3 seconds; and if the gamer performs a selection operation on the prop inheritance option within 3 seconds, the prop inheritance option is closed and the virtual prop interface of the virtual character is triggered. A specific value of the display duration of at least one of the prop prompt window, the decoration option, and the prop inheritance option is an example. By setting timers for the prop prompt window, the decoration option, and the prop inheritance option, the display time of the prop prompt window on the terminal screen can be effectively controlled, thereby preventing the prop prompt window from occupying the terminal screen for a long time and therefore avoiding obstruction of content on the terminal screen. For example, when the gamer actively controls the virtual character in the game scene, the gamer may not want to immediately perform prop replacement or inheritance upon receiving a target virtual prop. Therefore, setting a timer can not only prompt the gamer to obtain a new prop, but also avoid obstructing the screen for a long time, thereby improving game experience of the gamer.

For another example, if the gamer does not perform prop inheritance by using the prop prompt window, and the virtual character has a virtual prop of the same prop type as the target virtual prop but with a lower prop level, it is determined that the virtual character has a virtual prop capable of prop inheritance (that is, the target virtual prop). In this embodiment of this application, prompt information is outputted to prompt the gamer that prop inheritance can be performed. In this case, the prompt information is configured for prompting that the virtual character has a virtual prop capable of prop inheritance. The foregoing manner of using the prompt information to prompt the gamer with existence of the virtual prop capable of prop inheritance is equivalent to helping the gamer record prop inheritance when it is inconvenient for the gamer to perform prop inheritance by using the prop prompt window, so as to prevent the gamer from forgetting the existence of the virtual prop capable of prop inheritance, thereby making it easier for the gamer to grasp a prop inheritance situation and improving prop inheritance experience of the gamer.

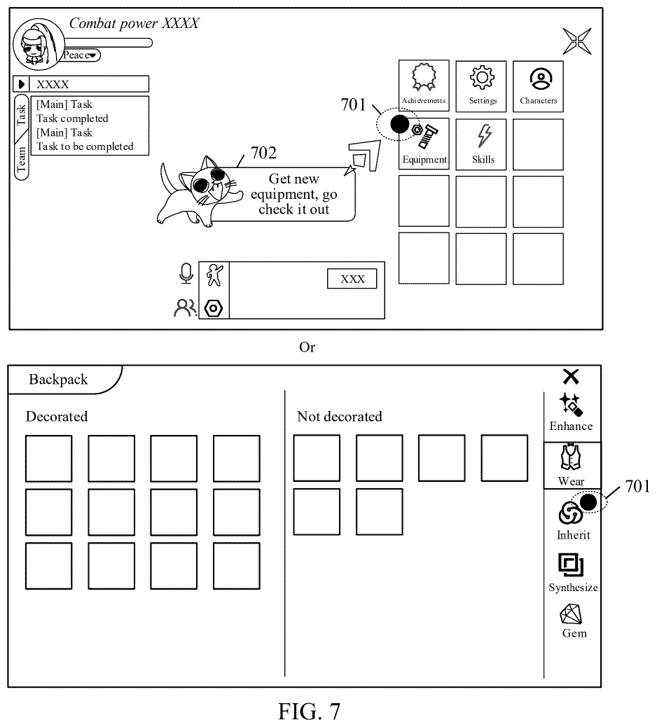

A display position and a display manner of the prompt information are not limited in embodiments of this application. For example, the prompt information may be displayed in the first access component in the foregoing game access interface, or displayed in the second access component in the foregoing virtual prop interface, or the like. The prompt information may be presented in a form of a text, an icon, a colored dot, or the like. For a diagram in which the prompt information is a dot, refer to FIG. 7. As shown in FIG. 7, when the virtual character has a virtual prop capable of prop inheritance, prompt information 701 may be displayed adjacent to the first access component in the game access interface, and/or the prompt information 701 may be displayed adjacent to the second access component in the virtual prop interface, and/or the like. A trigger condition of triggering the video game to output the prompt information to prompt the gamer to perform equipment inheritance is not limited to the foregoing descriptions that the gamer does not perform prop inheritance by using the prop prompt window and the virtual character has a virtual prop of the same type as the target virtual prop but with a lower prop level. The trigger condition may further include the video game periodically and automatically determine prop levels of virtual props of the same type of the virtual character, and when detecting that a virtual prop of a lower prop level in two virtual props of the same prop type has a transferable skill special effect set, may output prompt information to prompt the gamer that prop inheritance can be performed between the two virtual props, specifically, transfer the skill special effect set of the virtual prop of the lower prop level to a virtual prop of a higher prop level. Certainly, in addition to the dot shown in FIG. 7, the prompt information may further include other static or dynamic animations, images, sound effects, and the like, so as to better draw attention of the gamer to the prompt information, for example, an animation image 702 shown in FIG. 7.

S202: Receive a selection operation on a second virtual prop in at least one candidate virtual prop.

The virtual character controlled by the gamer in the video game is associated with the at least one candidate virtual prop. Specifically, the at least one candidate virtual prop may be a virtual prop that is associated with the virtual character but the virtual character is not equipped with and that has the same prop type as the first virtual prop selected for equipment inheritance. For example, the virtual character is associated with a virtual prop 1, a virtual prop 2, and a virtual prop 3 that are of a first prop type, and the virtual character has been equipped with the virtual prop 3. The virtual character is further associated with a virtual prop 4 and a virtual prop 5 that are of a second prop type, and the virtual character is equipped with neither the virtual prop 4 nor the virtual prop 5. Therefore, when the virtual prop 3 that the virtual character has been equipped with is selected as the first virtual prop, it is determined that candidate virtual props associated with the virtual character include the virtual prop 1 and the virtual prop 2 that are of the same prop type as the virtual prop 3.

As described above, the first virtual prop selected for equipment inheritance may be displayed in the virtual prop interface of the virtual character; and the virtual prop interface further includes a third display region, and the third display region is mainly configured for presenting prop information of the selected second virtual prop. Therefore, after the gamer selects the second virtual prop from the at least one candidate virtual prop, the prop information of the second virtual prop may be displayed in the third display region in the virtual prop interface, so that the gamer intuitively senses the selected second virtual prop, and the gamer performs secondary confirmation on the selected second virtual prop, thereby avoiding a misoperation.

Specific selection processes in which the gamer selects the second virtual prop from the at least one candidate virtual prop associated with the virtual character are also different based on different interface content included in the virtual prop interface. The following provides two exemplary specific implementation processes of selecting the second virtual prop.

The virtual prop interface includes a prop selection option, and the second virtual prop is selected from the at least one candidate virtual prop by using the prop selection option.

Specifically, the virtual prop interface of the virtual character further includes the prop selection option. In this way, when the gamer has the second virtual prop selected for equipment inheritance, the gamer may perform a trigger operation on the prop selection option in the virtual prop interface. In this case, the terminal device may display a prop presentation window in response to the trigger operation on the prop selection option that is received on the terminal screen. The prop presentation window includes a prop type and the at least one candidate virtual prop having the same prop type as the first virtual prop. Then, the gamer may select the second virtual prop from the at least one candidate virtual prop in the prop presentation window. By setting the prop selection option in the virtual prop interface, the at least one candidate virtual prop may be quickly accessed by using the prop selection option, thereby improving convenience of selecting the second virtual prop, and improving user experience.

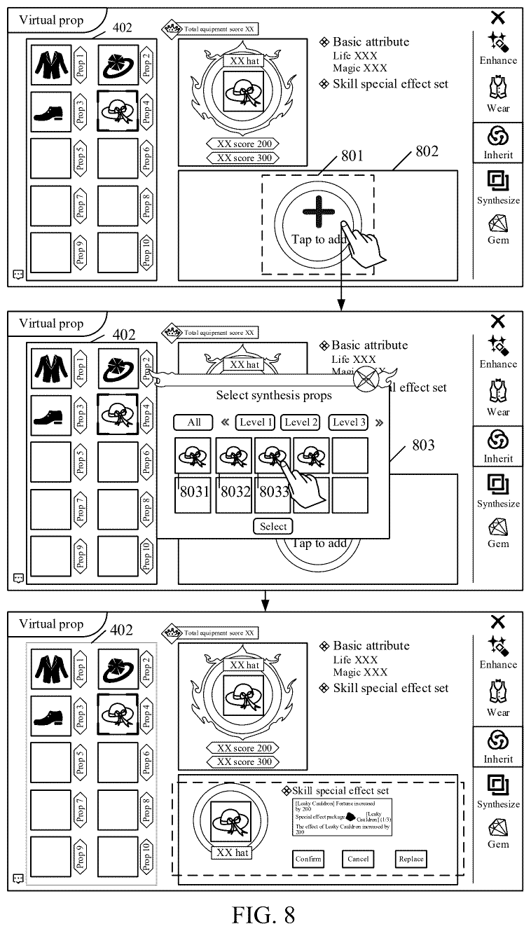

For an exemplary interface diagram of selecting the second virtual prop from the at least one candidate virtual prop by using the prop selection option, refer to FIG. 8. As shown in FIG. 8, the virtual prop interface of the virtual character includes a prop selection option 801, and the prop selection option 801 may be displayed at any display position in the virtual prop interface (as shown in FIG. 8, the prop selection option 801 is displayed in a third display region 802 in the virtual prop interface). A prop presentation window 803 is displayed when the gamer performs a trigger operation on the prop selection option 801 in the virtual prop interface. The prop presentation window 803 may be presented in a form of a floating layer window as shown in FIG. 8, or may be displayed in a form of an independent interface. A presentation form of the prop presentation window 803 is not limited in embodiments of this application. The prop presentation window 803 includes at least one candidate virtual prop (specifically, includes a prop identifier of the candidate virtual prop) associated with the virtual character, such as a candidate virtual prop 8031, a candidate virtual prop 8032, and a candidate virtual prop 8033. In this way, the gamer may select any candidate virtual prop from the prop presentation window 803 according to an inheritance requirement of the gamer, use the selected candidate virtual prop as the second virtual prop, and display the prop information of the second virtual prop in the third display region 802 in the virtual prop interface.

The virtual prop interface further includes a second display region, and the second virtual prop is selected from the at least one candidate virtual prop through a drag operation of moving the candidate virtual prop from the second display region to the third display region.

Specifically, the virtual prop interface of the virtual character further includes the second display region, and the second display region is configured for presenting the at least one candidate virtual prop having the same prop type as the first virtual prop. In other words, in this embodiment of this application, the prop information of the selected first virtual prop can be displayed in the first display region in the virtual prop interface, the candidate virtual prop having the same prop type as the first virtual prop can be displayed in the second display region in the virtual prop interface, and the prop information of the selected second virtual prop can be displayed in the third display region in the virtual prop interface. In this implementation, the gamer may directly perform a selection operation in the second display region in the virtual prop interface. In this case, in response to the selection operation performed in the second display region, the terminal device determines, from the at least one candidate virtual prop displayed in the second display region, the second virtual prop determined based on the selection operation performed by the gamer. The selection operation performed by the gamer in the second display region includes a trigger operation (such as a tap operation, a double-tap operation, or a touch and hold operation) on the second virtual prop in the second display region, or a drag operation of moving the second virtual prop from the second display region to the third display region. A specific implementation of the selection operation of selecting the second virtual prop is not limited in embodiments of this application. The second virtual prop can be directly selected in the second display region in the virtual prop interface without interface switching or jumping, thereby shortening an operation path for selecting the second virtual prop, and improving convenience of selecting the second virtual prop.

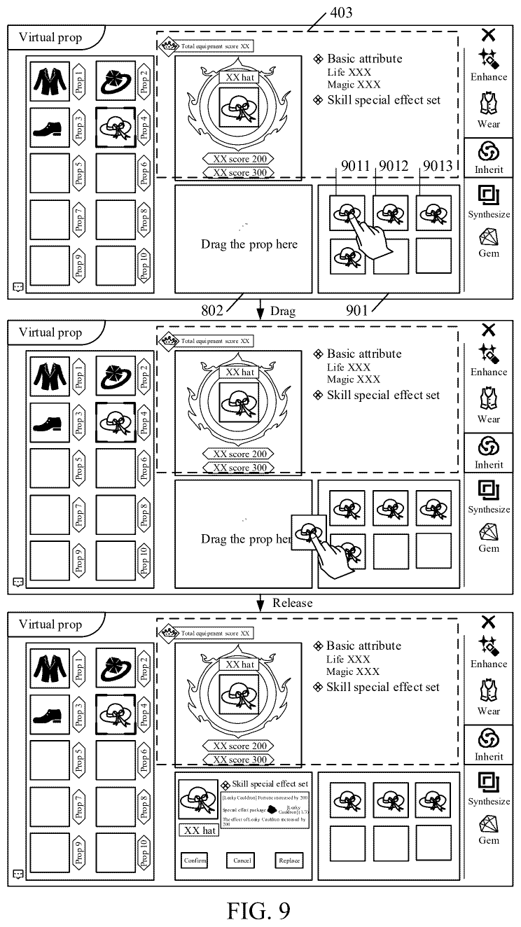

An example in which the selection operation is a drag operation is used below to provide an interface procedure of selecting the second virtual prop from the at least one candidate virtual prop based on the drag operation. As shown in FIG. 9, the virtual prop interface of the virtual character includes a first display region 403, a second display region 901, and a third display region 802. The first display region 403 is configured for presenting the prop information of the first virtual prop selected for equipment inheritance, the second display region 901 is configured for presenting the at least one candidate virtual prop having the same prop type as the first virtual prop, and the third display region 802 is configured for presenting the prop information of the second virtual prop selected from the at least one candidate virtual prop. Assuming that the second display region 901 includes a candidate virtual prop 9011, a candidate virtual prop 9012, and a candidate virtual prop 9013, and the gamer wants to select the candidate virtual prop 9011 as the second virtual prop for equipment inheritance, the gamer may perform a selection operation on the candidate virtual prop 9011 in the second display region 901. For example, the selection operation includes releasing a drag operation of pressing the candidate virtual prop 9011 after the candidate virtual prop 9011 is pressed continuously and the candidate virtual prop 9011 is moved to the third display region 802. After the selection operation is performed on the candidate virtual prop 9011 in the second display region 901, prop information of the candidate virtual prop 9011 may be displayed in the third display region 802 in the virtual prop interface, to visually prompt the gamer that the candidate virtual prop 9011 has been selected as the second virtual prop.

FIG. 9 merely provides exemplary display styles and display positions of three display regions (the first display region, the second display region, and the third display region) in the virtual prop interface. During actual application, the display styles and display positions of the three display regions may be changed. This is not limited in embodiments of this application.

Further, considering that a display area of the second display region in the virtual prop interface is limited, the gamer can only better select the second virtual prop that is more suitable for equipment inheritance while mastering more detailed prop information of the candidate virtual prop. To help the gamer view more detailed prop information of a candidate virtual prop, in this embodiment of this application, prop information of any candidate virtual prop can be further previewed from the second display region, to help the gamer view the prop information of the candidate virtual prop.

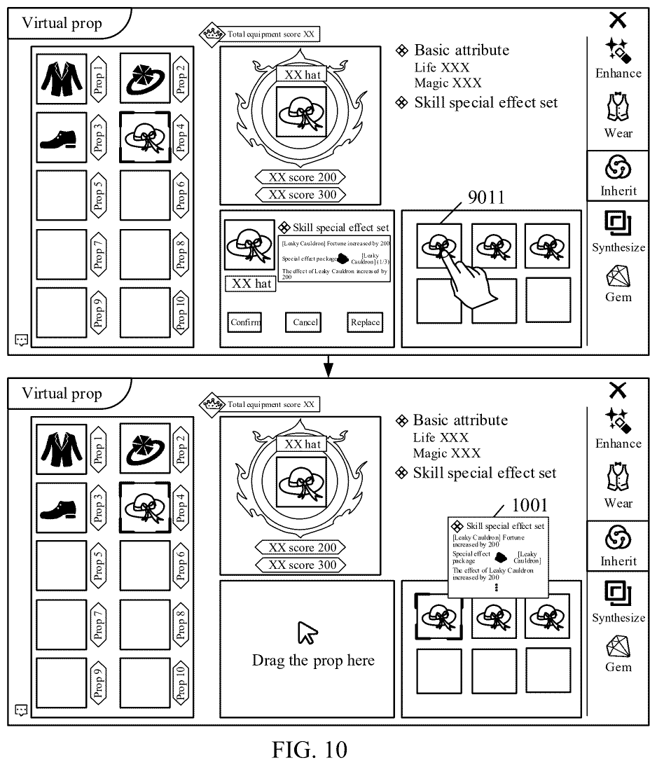

During specific implementation, a process of previewing prop information of a candidate virtual prop in the second display region may include: If the gamer has a requirement of viewing prop information of any candidate virtual prop in the second display region, the gamer may perform a preview operation on the any candidate virtual prop. In this case, the terminal device may output a preview window in the virtual prop interface in response to the preview operation of the gamer on the any candidate virtual prop in the second display region. In this way, the prop information of the any candidate virtual prop on which the preview operation is performed may be displayed in the preview window. For an interface diagram of the preview window, refer to FIG. 10. The second display region includes the candidate virtual prop 9011. If the gamer wants to view the prop information of the candidate virtual prop 9011, the gamer may perform a preview operation on the candidate virtual prop 9011. In this way, the terminal device may output a preview window 1001 in response to the preview operation on the candidate virtual prop 9011, and present the prop information of the candidate virtual prop 9011 in the preview window 1001.

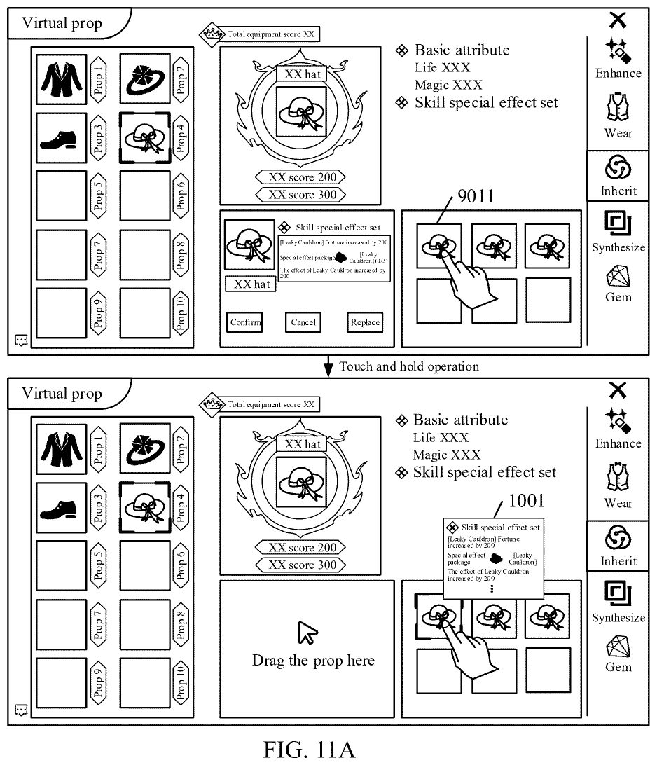

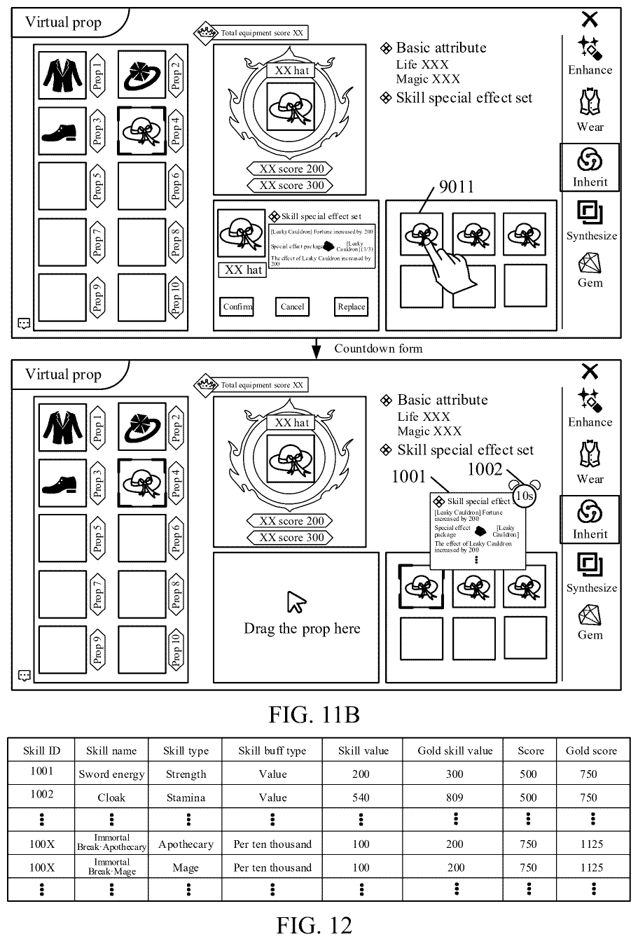

A specific implementation of a preview operation performed on a candidate virtual prop is not limited in embodiments of this application. Display duration and a display manner of the preview window also vary with a preview operation. For example, the preview operation includes any one of the following: 1. Touch and hold operation on any candidate virtual prop: When the preview operation is a touch and hold operation on the candidate virtual prop, display of the preview window is canceled in the virtual prop interface if the touch and hold operation on the candidate virtual prop is canceled. In other words, display duration of the preview window is the same as execution duration of the touch and hold operation. The preview window is displayed as the touch and hold operation is performed, and display is canceled as the touch and hold operation ends. As shown in FIG. 11A, when the gamer performs a touch and hold operation on the candidate virtual prop 9011 in the second display region, the preview window 1001 is triggered to be displayed, and the preview window 1001 includes the prop information of the candidate virtual prop 9011. When the touch and hold operation on the candidate virtual prop 9011 is canceled, display of the preview window 1001 is canceled. This manner of displaying the preview window based on the execution duration of the touch and hold operation of the gamer helps the gamer control the display duration of the preview window, thereby satisfying a display requirement of personalized control of the preview window by the gamer. 2. Trigger operation on any candidate virtual prop: When the preview operation is a trigger operation on the candidate virtual prop, the preview window is displayed in the virtual prop interface in a countdown form. In other words, after the trigger operation is performed on the candidate virtual prop in the second display region, the preview window is displayed, display duration of the preview window is fixed, and remaining display duration is displayed in the preview window in a countdown form. As shown in FIG. 11B, when the gamer performs a trigger operation on the candidate virtual prop 9011 in the second display region, the preview window 1001 is triggered to be displayed, and a countdown 1002 is displayed once, to notify the gamer of remaining display duration of the preview window 1001 by using the countdown 1002.

S203: Transfer a skill special effect set of the second virtual prop to the first virtual prop.

During specific implementation, after the first virtual prop and the second virtual prop for equipment inheritance are determined through the foregoing operations, the skill special effect set of the second virtual prop can be transferred to the first virtual prop, to implement equipment inheritance between the first virtual prop and the second virtual prop. The skill special effect set of the second virtual prop includes a special effect resource corresponding to a game skill. In addition, the virtual character equipped with the second virtual prop has skill strength matching a special effect resource when using a game skill in the virtual scene. The matching herein means that a larger quantity of special effect resources indicates higher skill strength of a game skill when the virtual character uses the game skill. In this way, after the skill special effect set of the second virtual prop is transferred to the first virtual prop, the second virtual prop is directly deleted from a virtual backpack of the virtual character. The virtual backpack simulates a backpack in the real world, and can be configured for storing a virtual prop of the virtual character in the video game. In addition, the skill special effect set of the second virtual prop is added to the first virtual prop, so that the first virtual prop has the skill special effect set of the second virtual prop after the skill special effect set is transferred. The virtual character equipped with the first virtual prop has skill strength matching a special effect resource when using a game skill in the virtual scene.

The following describes the skill special effect set in detail: The skill special effect set of the second virtual prop is a set including a special effect resource (or referred to as a special effect entry) collected for the second virtual prop. Specifically, the skill special effect set includes N special effect groups, Nis a positive integer, and one of the N special effect groups corresponds to one game skill. The special effect group includes a special effect resource corresponding to a corresponding game skill. The game skill may be a game manner that causes attack, defense, assistance, or another effect through a game behavior in the video game. The game skill has a skill level. A higher skill level indicates higher skill strength of the game skill. For example, if the game skill is a defense skill, a higher skill level of the defense skill indicates higher damage that the virtual character can withstand when using the defense skill.

Further, a skill level of a game skill may be improved by cultivating a special effect resource corresponding to the game skill. The special effect resource is a basic unit for cultivating the skill level of the game skill. Specifically, a quantity of special effect resources included in a special effect group is in positive correlation with skill strength of a corresponding game skill. In other words, a larger quantity of special effect resources corresponding to a game skill included in the special effect group indicates a higher skill level of the corresponding game skill, that is, higher skill strength of the corresponding game skill. In other words, a quantity of special effect resources corresponding to a game skill may represent proficiency of the virtual character on the game skill. A larger quantity of special effect resources indicates higher proficiency, that is, higher skill strength of the game skill. For example, when a quantity of special effect resources corresponding to a game skill is 1, proficiency is beginner, and skill strength of the game skill may be 100; when a quantity of special effect resources corresponding to a game skill is 2, proficiency is skilled, and skill strength of the game skill may be 200; and the like. For another example, each time a quantity of special effect resources corresponding to a game skill is increased by 1, skill strength of the game skill is increased by a corresponding value (for example, 200 or increased by 2% based on an original skill strength value).

Prop levels of virtual props to which game skills belong are different, and when a quantity of special effect resources corresponding to a game skill increases, buff degrees of skill strength of the corresponding game skill are different. The buff degree means an increase degree by which skill strength is increased to current skill strength. For example, if a current skill level is 100, and a buff degree is 10%, new skill strength is 110 after the skill strength is increased by one buff degree. For example, to motivate the gamer to pursue a virtual prop of a higher level, a higher prop level of a virtual prop may be set to indicate a larger buff degree of skill strength of a corresponding game skill when a quantity of special effect resources corresponding to the game skill of the virtual prop increases. As described above, prop levels of virtual props may sequentially include green, blue, purple, orange, and gold in ascending order. Therefore, it is determined that the prop level of the gold virtual prop is the highest, and a value of a special effect resource of the gold virtual prop is unique. For example, the value of the special effect resource of the gold virtual prop may be added by 50%. In this way, it is ensured that more skill strength can be added to the gold prop when a special effect resource is collected, and it can be further ensured that the gamer can further continue to pursue remaining 50% after the gold prop inherits a skill special effect set of a prop of another level, so that the gamer has a motivation to continue pursuing. For an exemplary diagram of a gold prop buff, refer to FIG. 12. As shown in FIG. 12, if a skill value of a game skill whose skill ID is 1001 is 200, when a prop level of a virtual prop is a highest level (such as a gold level), the skill value of the game skill may be added by 50% based on 200, that is, the skill value of the game skill of the virtual prop of the highest level can reach 200+200*50%=300.

Further, skill strength of a game skill has an upper limit. In other words, a quantity of special effect resources corresponding to one game skill cannot be infinitely increased. To motivate the gamer to pursue higher skill strength of a game skill, that is, collect more special effect resources corresponding to the game skill, in this embodiment of this application, when a quantity of special effect entries reaches an upper limit, the skill strength of the corresponding game skill can be multiplied, so that the gamer obtains higher skill strength when cultivating the game skill to reach the upper limit, thereby enriching skill cultivation forms, and increasing interest of the gamer in game skill cultivation. In this embodiment of this application, when a quantity of special effect resources included in a special effect group reaches the upper limit, skill strength obtained by a corresponding game skill is referred to as a special effect package. The special effect package multiplies skill strength of a game skill. In other words, the skill strength of the game skill in the special effect package is a sum of skill strength during the quantity of special effect resources corresponding to the game skill being the upper limit and reference skill strength; and the reference skill strength is skill strength added to the game skill when the quantity of special effect resources included in the special effect group reaches the upper limit.

The upper limit that can be reached by the quantity of special effect resources corresponding to the game skill is positively correlated with a prop level of a virtual prop to which the game skill belongs. In other words, a higher prop level of a virtual prop indicates a higher special effect resource upper limit of the virtual prop. In this way, after a higher-level virtual prop inherits a lower-level skill special effect set, there is still room for pursuit, that is, a special effect resource can be continuously collected to cultivate a game skill, so that the gamer can continuously have linear pursuit experience. For example, as described above, the prop levels of the virtual props may sequentially include green, blue, purple, orange, and gold in ascending order. Therefore, for an upper limit of a quantity of special effect resources corresponding to each prop level, refer to Table 1:

TABLE 1

| | Upper limit of a quantity of special effect |
|---|---|
| Prop level (color) | resources |
| Green level | 1 |
| Blue level | 2 |
| Purple level | 3 |
| Orange level | 6 |
| Gold level | 10 |

It can be learned from Table 1 that a higher prop level indicates a higher upper limit of a quantity of special effect resources corresponding to a game skill of a virtual prop. For example, after obtaining a virtual prop of an orange level and transferring a historically obtained skill special effect set (for example, including three special effect groups, each special effect group including one special effect resource) of a virtual prop of a purple level and of the same type to the virtual prop of the orange level, the gamer determines that the virtual prop of the orange level has the skill special effect set of the virtual prop of the purple level, that is, has three special effect groups, and each special effect group includes one special effect resource. Therefore, when the upper limit of the quantity of special effect resources corresponding to the virtual prop of the orange level is 6, the gamer may further continue to pursue each of the three special effect groups owned by the virtual prop of the orange level through equipment synthesis.

In this embodiment of this application, a skill special effect set (specifically, a special effect resource/a special effect entry) of a low-quality virtual prop is transferred to a high-quality virtual prop losslessly, thereby preventing the first virtual prop from being cultivated from the very beginning, avoiding fragmented cultivation between different virtual props in a conventional game, and improving flexibility of transferring a skill special effect set between virtual props. In addition, an upper limit of a quantity of special effect resources corresponding to the high-quality virtual prop is greater than an upper limit of a quantity of special effect resources corresponding to the low-quality virtual prop. Therefore, even if the skill special effect set of the low-quality prop is transferred to the high-quality prop, there is still room for pursuit for the high-quality prop, that is, a special effect resource can continue to be collected for game skill cultivation. In addition, equipment inheritance provided in this embodiment of this application is specifically inheriting a skill special effect set, and keeping an attribute of a virtual prop from being inherited. This can enable the attribute of the virtual prop to be always used as the pursuit of the virtual prop (for example, when the virtual prop is initially obtained, an attribute value of the attribute of the virtual prop is only 80% of a maximum attribute value, and remaining 20% of the attribute value still needs to be pursued through equipment synthesis), thereby satisfying a requirement of the gamer to pursue the attribute of the virtual prop.

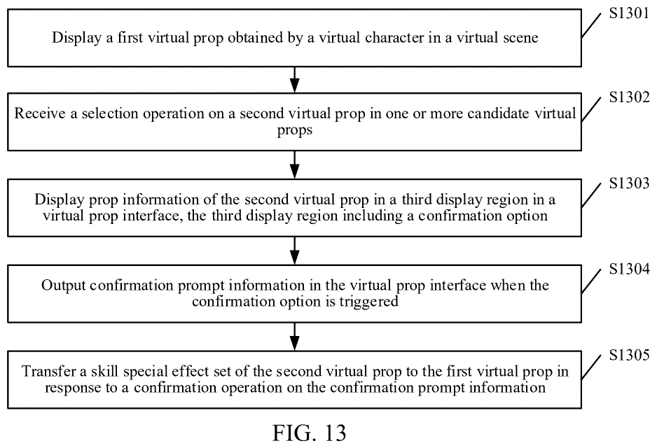

Refer to FIG. 13. FIG. 13 is a schematic flowchart of another game processing method according to an exemplary embodiment of this application. The method may be performed by the terminal device mentioned above, or may be performed by a game application deployed in the terminal device. For ease of description, an embodiment of this application is described by using an example in which the terminal device performs the game processing method. As shown in FIG. 13, the game processing method may include the following operations S1301 to S1305.

S1301: Display a first virtual prop obtained by a virtual character in a virtual scene.

S1302: Receive a selection operation on a second virtual prop in at least one candidate virtual prop.

A specific implementation process shown in operations S1301 and S1302 is similar to a specific implementation process shown in operations S201 and S202 in the embodiment shown in FIG. 2, and reference may be made to the related descriptions of operations S201 and S202. Details are not described herein again.

Considering that the at least one candidate virtual prop associated with the virtual character belongs to a plurality of prop levels (such as the gold level, the purple level, or the blue level mentioned above), it is convenient for a gamer to select a candidate virtual prop of a specified prop level. In this embodiment of this application, a candidate virtual prop of any prop level in the at least one candidate virtual prop can be independently displayed according to a requirement of the gamer. It is convenient for the gamer to select the second virtual prop from at least one candidate virtual prop of a specified prop level, thereby implementing prop inheritance between the second virtual prop of the specified prop level and the first virtual prop, and satisfying a game requirement of obtaining a candidate virtual prop of the specified prop level by the gamer through screening.

During specific implementation, the at least one candidate virtual prop associated with the virtual character in operation S202 may be displayed in a prop presentation window or displayed in a second display region in a virtual prop interface. For ease of description, either of the prop presentation window and the second display region can be represented as a target interface. In this embodiment of this application, level options respectively corresponding to a plurality of prop levels can be set in the target interface. In other words, the target interface may include a plurality of level options, and one level option in the plurality of level options corresponds to one prop level. In this way, when the gamer wants to obtain a candidate virtual prop of a specified prop level through screening, the gamer may perform a trigger operation on a level option corresponding to the prop level in the target interface. In this case, the terminal device may display, in the target interface based on the trigger operation on the level option in the target interface, a candidate virtual prop of a prop level indicated by the triggered level option.

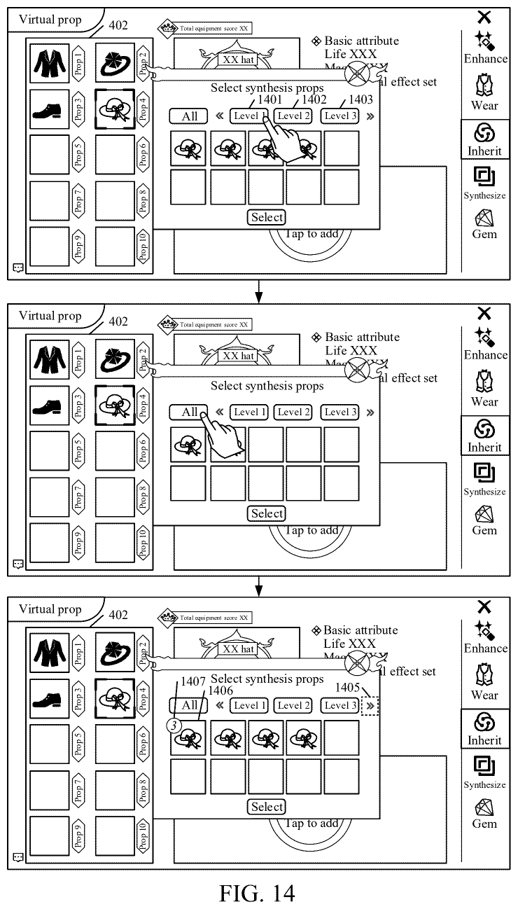

For example, the target interface is a prop presentation window. As shown in FIG. 14, the prop presentation window may include a level option corresponding to each of a plurality of prop levels, for example, a level option 1401 corresponding to a first prop level, a level option 1402 corresponding to a second prop level, and a level option 1403 corresponding to a third prop level. The gamer may perform a trigger operation on any level option. In this case, only a candidate virtual prop of a prop level corresponding to the triggered level option is presented in the prop presentation window. If the level option 1401 is triggered, only a candidate virtual prop of a prop level corresponding to the level option 1401 is presented in the prop presentation window. Still refer to FIG. 14. To help the gamer view all candidate virtual props, an all option 1404 can be further set in the prop presentation window; and in response to a trigger operation on the all option 1404, all the candidate virtual props that are associated with the virtual character and that are of the same type as the first virtual prop may be presented in the prop presentation window.

FIG. 14 is merely an exemplary diagram of displaying a level option in a target interface (such as a prop presentation window) according to an embodiment of this application. An interface element included in the target interface is not limited in embodiments of this application. For example, because there are usually many prop levels and a display area of the prop presentation window is limited, level options corresponding to only some of a plurality of prop levels can be displayed in the prop presentation window, and remaining level options can only be hidden. To make it convenient for the gamer to view all level options, in this embodiment of this application, the gamer can further perform a slide operation to display a hidden level option in the prop presentation window. Certainly, the hidden level option may alternatively be displayed by triggering an expansion component 1405 in the prop presentation window.

For another example, to help the gamer view key information related to the candidate virtual prop and equipment inheritance in the limited target interface, the second virtual prop configured for equipment inheritance is better selected. In this embodiment of this application, prop prompt information (such as the foregoing key information) corresponding to each of the at least one candidate virtual prop can be displayed in the target interface. In this way, the gamer may view the prop prompt information of the candidate virtual prop to select the second virtual prop, thereby helping the gamer select the second virtual prop after fully learning the prop details, helping the gamer select the desired second virtual prop, and improving experience of the gamer. Specific content of the prop prompt information of the candidate virtual prop is related to equipment inheritance, and the correlation is embodied in that the prop prompt information corresponding to the candidate virtual prop may indicate a set special effect of a skill special effect set of the corresponding candidate virtual prop. For example, the prop prompt information corresponding to the candidate virtual prop includes at least one of the following: 1. Quantity of skill types of game skills included in the skill special effect set: If the quantity of skill types of the game skills of the candidate virtual prop is 3, the candidate virtual prop already starts to cultivate three game skills. In this case, prop prompt information “3” is displayed adjacent to the candidate virtual prop in the target interface. 2. Quantity of special effect resources included in the skill special effect set: If three special effect entries have been collected for the candidate virtual prop in total, prop prompt information 1407 may be displayed adjacent to the candidate virtual prop shown in FIG. 14 (for example, a candidate virtual prop 1406). 3. Quantity of special effect packages included in the skill special effect set: If two special effect packages have been cultivated for the candidate virtual prop, that is, a quantity of special effect entries corresponding to two game skills of the candidate virtual prop reaches an upper limit, prop prompt information “2” is displayed adjacent to the candidate virtual prop in the target interface.

In addition, as described above, to ensure that the gamer can pursue a higher-quality virtual prop, in this embodiment of this application, a prop level of the first virtual prop may be set to be greater than a prop level of the second virtual prop. Based on this, in this embodiment of this application, after it is detected that the gamer selects the second virtual prop from the at least one candidate virtual prop, level comparison between the first virtual prop and the second virtual prop is further supported, to ensure that the prop level of the second virtual prop needs to be lower than the prop level of the first virtual prop, thereby helping the gamer pursue a high-quality prop.

During specific implementation, when detecting that the second virtual prop is selected from the at least one candidate virtual prop, the terminal device separately obtains the prop level of the first virtual prop and the prop level of the second virtual prop, and compares the prop level of the second virtual prop with the prop level of the first virtual prop, to obtain a comparison result. If the comparison result indicates that the prop level of the second virtual prop is lower than the prop level of the first virtual prop, operation S1303 may be triggered to be performed. Otherwise, if the comparison result indicates that the prop level of the second virtual prop is higher than the prop level of the first virtual prop, the selected second virtual prop cannot perform prop inheritance with the first virtual prop. In this case, feedback information is outputted. The feedback information indicates a failure of prop inheritance between the first virtual prop and the second virtual prop.

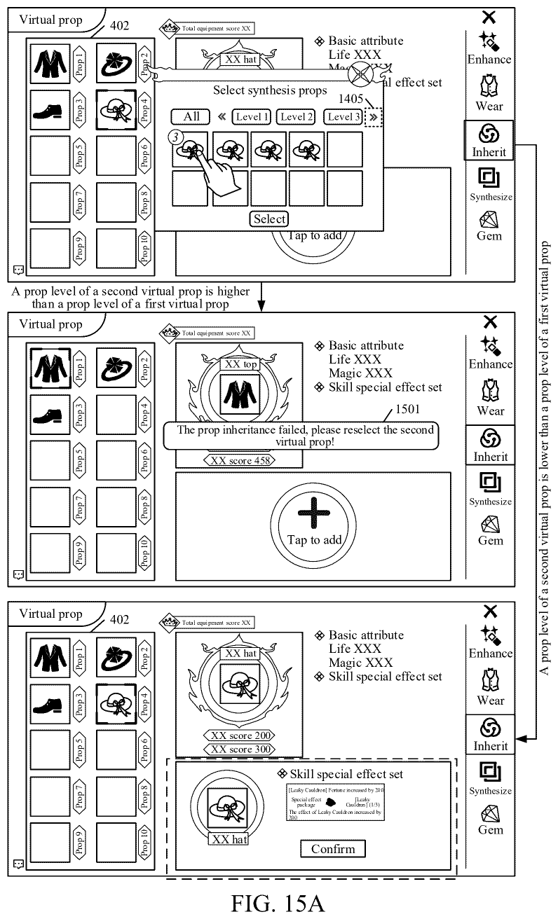

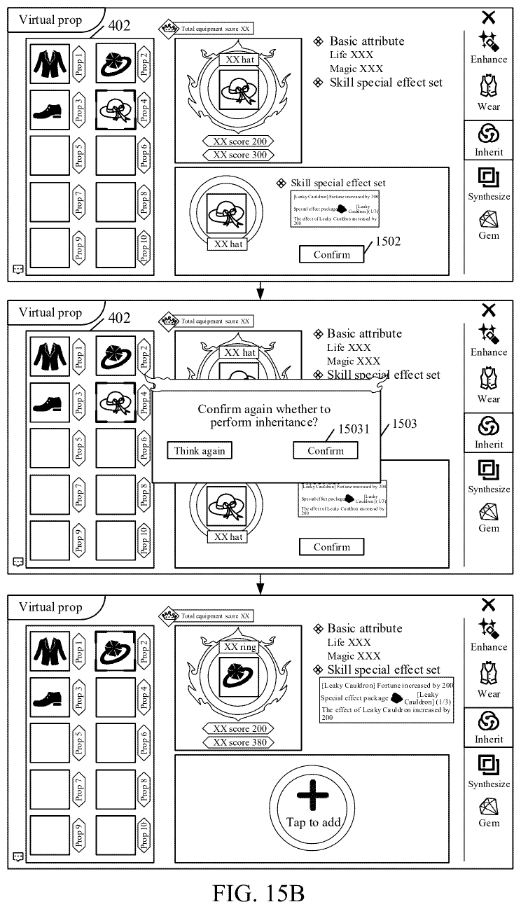

The foregoing feedback information is described below with reference to FIG. 15A. As shown in FIG. 15A, after the gamer selects the second virtual prop, the terminal device or a server compares the prop level of the first virtual prop with the prop level of the second virtual prop. If the comparison result indicates that the prop level of the second virtual prop is lower than the prop level of the first virtual prop, prop information of the second virtual prop is displayed in a third display region. Otherwise, when the comparison result indicates that the prop level of the second virtual prop is higher than the prop level of the first virtual prop, feedback information 1501 is outputted, the feedback information 1501 prompts that the second virtual prop does not have permission to perform prop inheritance with the first virtual prop, and the prop information of the second virtual prop is not displayed in the third display region.

S1303: Display the prop information of the second virtual prop in the third display region in the virtual prop interface, the third display region including a confirmation option.

S1304: Output confirmation prompt information in the virtual prop interface when the confirmation option is triggered.

S1305: Transfer a skill special effect set of the second virtual prop to the first virtual prop in response to a confirmation operation on the confirmation prompt information.

In operations S1303 to S1305, after the gamer selects the second virtual prop from the at least one candidate virtual prop associated with the virtual character, to help the gamer preview the prop information of the selected second virtual prop, in this embodiment of this application, the prop information of the second virtual prop can be displayed in the third display region in the virtual prop interface. The third display region further includes the confirmation option. When the gamer performs a trigger operation on the confirmation option in the third display region, the gamer confirms to transfer the skill special effect set of the second virtual prop to the first virtual prop. Therefore, after the skill special effect set is transferred, the second virtual prop is deleted from the third display region, and the skill special effect set of the second virtual prop is displayed in a first display region. In other words, after the skill special effect set is transferred, the skill special effect set of the second virtual prop and prop information of the first virtual prop are displayed together in the first display region, so that the gamer can intuitively sense an inheritance process of the skill special effect set, that is, the gamer can intuitively sense that the skill special effect set of the second virtual prop is inherited to the first virtual prop provided that the gamer observes the first display region, thereby improving experience of the gamer.

Further, a confirmation option (a confirmation option 1502 shown in FIG. 15B) is displayed in the third display region in the virtual prop interface. If the gamer confirms to transfer the skill special effect set of the second virtual prop in the third display region to the first virtual prop, the gamer may perform a trigger operation on the confirmation option, and the terminal outputs confirmation prompt information (confirmation prompt information 1503 shown in FIG. 15B) in the virtual prop in response to the trigger operation, so that the gamer confirms again whether to perform prop inheritance between the second virtual prop and the first virtual prop. If the gamer performs a confirmation operation on the confirmation prompt information (for example, taps a determining option 15031 in the confirmation prompt information 1503), the gamer transfers the skill special effect set of the second virtual prop to the first virtual prop, displays the skill special effect set of the second virtual prop in the first display region, deletes the entire second virtual prop, and cancels display of the prop information of the second virtual prop in the third display region.

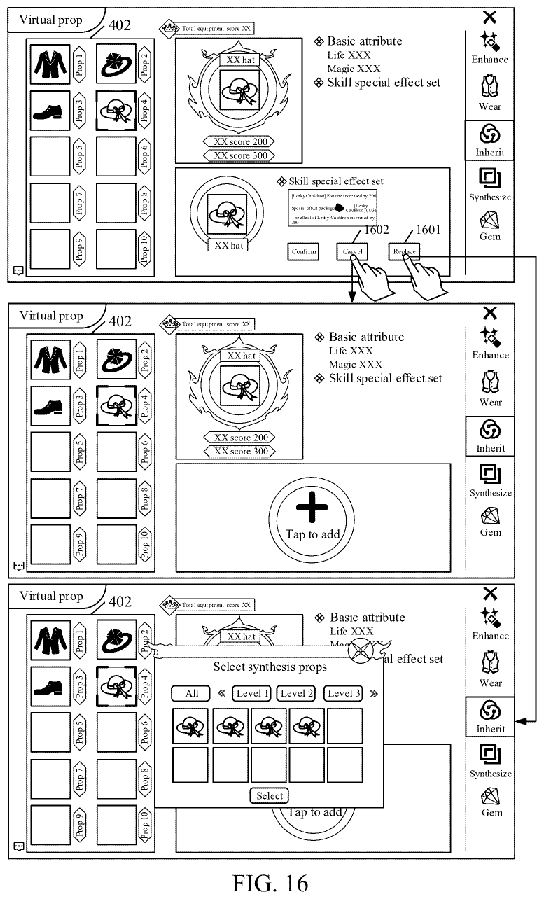

In addition, the gamer may change intention after selecting the second virtual prop, for example, want to select another candidate virtual prop as the second virtual prop, or cancel a virtual prop in the third display region as the second virtual prop. Therefore, to enrich operation rights of the gamer, in this embodiment of this application, a replacement option and a cancel option can be further set in the third display region. As shown in FIG. 16, a replacement option 1601 and a cancel option 1602 are displayed in a third display region of a virtual prop. When the gamer performs a trigger operation on the replacement option 1601, a prop presentation window is triggered to be displayed, so that the gamer can continue to select a new candidate virtual prop from the prop presentation window to replace the second virtual prop displayed in the third display region. Similarly, when the gamer performs a trigger operation on the cancel option 1602, display of the prop information of the second virtual prop is directly canceled in the third display region, indicating that the gamer cancels selection of a candidate virtual prop in the third display region as the second virtual prop.

In addition, in this embodiment of this application, the gamer can further view a historical inheritance record in real time, thereby helping the gamer trace equipment inheritance in a historical time period. There may be one or more types of equipment inheritance in the historical time period. In this embodiment of this application, equipment inheritance between the first virtual prop and the second virtual prop is used as an example, and prop inheritance between the first virtual prop and the second virtual prop is recorded and stored. In this way, when the gamer has a tracing requirement, the gamer may perform a view operation in the virtual prop interface. In this case, the terminal device displays a query interface in response to the view operation for the prop inheritance in the virtual prop interface, and displays record information of prop inheritance between the first virtual prop and the second virtual prop in a log form in the view interface. 1. The view operation performed by the gamer in the virtual prop interface is not limited in embodiments of this application. For example, the view operation may include any one of the following: a gesture operation (such as an “S”-shaped movement operation, a two-finger pinch operation, or a three-tap operation), a trigger operation, or a voice input operation (in a process of displaying the virtual prop interface, a microphone of the terminal device is in a turned-on state, so that when capturing a voice signal that is in a physical environment and that instructs to view a prop inheritance record, the microphone determines that the voice input operation is detected). 2. An information type of the record information of the prop inheritance between the first virtual prop and the second virtual prop is not limited in embodiments of this application, and includes at least the skill special effect set (such as a special effect resource and a special effect package) transferred from the second virtual prop to the first virtual prop, a prop identifier of the first virtual prop, a prop identifier of the second virtual prop, attribute information (a basic attribute, such as a life attribute or a magic attribute) of the first virtual prop, attribute information of the second virtual prop, and the like. 3. A display form of the record information in the view interface is not limited in embodiments of this application. For example, the prop inheritance between the first virtual prop and the second virtual prop can be stored in a log form, so that the record information is presented in a log form. For another example, the prop inheritance between the first virtual prop and the second virtual prop can be stored in a table form, so that the record information is presented in a table form.

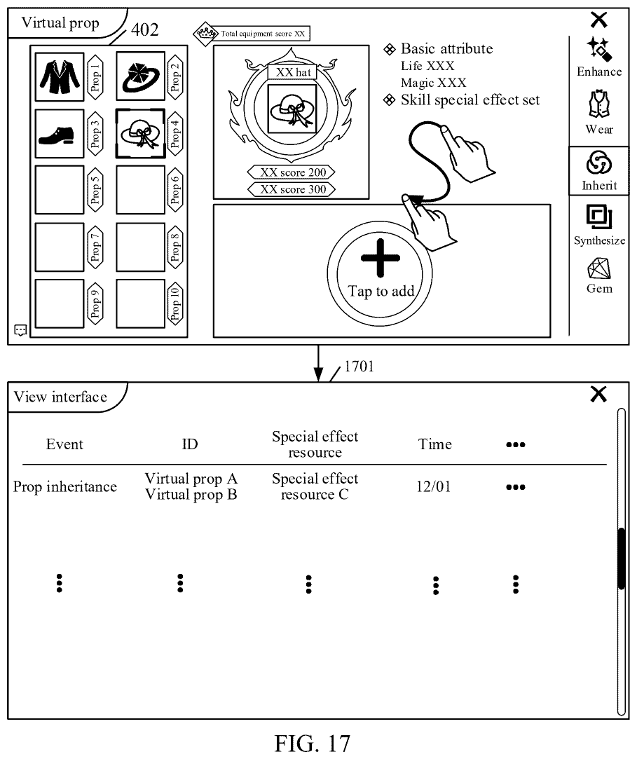

For example, an interface procedure of triggering to display a view interface is provided with reference to FIG. 17 by using an example in which a view operation is a gesture operation. As shown in FIG. 17, when the gamer has a requirement of viewing historical prop inheritance, the gamer may perform a gesture operation (for example, the gesture operation is a movement operation of drawing an “S” shape) in the virtual prop interface, and then a view interface 1701 may be triggered to be displayed in response to the gesture operation in the virtual prop interface. The view interface 1701 may be displayed in a form of a floating window, or may be displayed in a form of an independent interface. This is not limited. In addition, record information of each time of prop inheritance in one or more times of prop inheritance in a historical time period is displayed in the view interface 1701. As shown in FIG. 17, record information of prop inheritance between a virtual prop A and a virtual prop B is displayed in a log form, and the record information includes at least information such as a prop identifier (or an ID) of the virtual prop A, a prop identifier of the virtual prop B, a transferred special effect resource, and a transfer time.

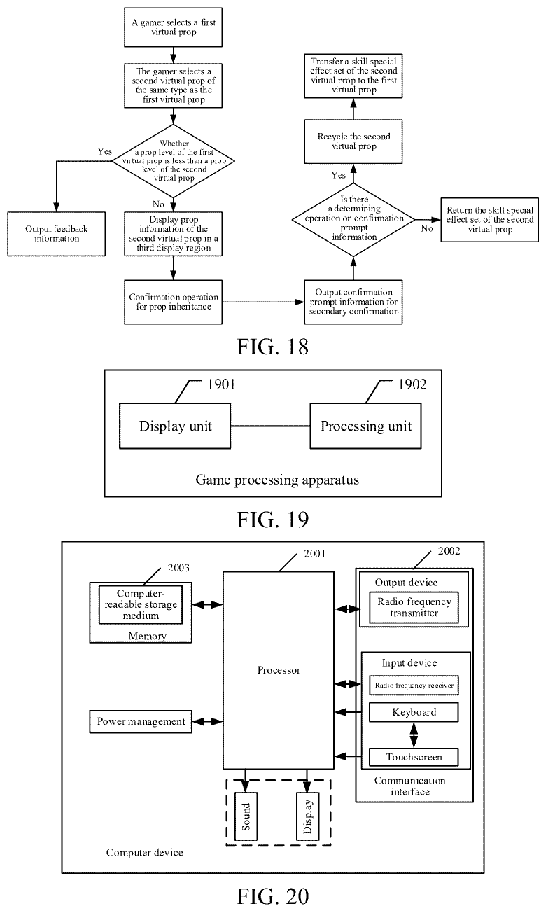

The foregoing embodiments shown in FIG. 2 and FIG. 13 mainly describe the game processing method provided in embodiments of this application from an interface dimension. The following provides a background processing procedure of the game processing method with reference to FIG. 18. The background processing procedure may be performed by the terminal device and/or the server in the system shown in FIG. 1. For ease of description, an example in which the terminal device and the server jointly perform the background processing procedure is used. As shown in FIG. 18, the terminal device may transmit the first virtual prop (for example, the prop identifier of the first virtual prop) to the server after detecting a selection operation of the gamer on the first virtual prop, and the server records a high-quality prop to be configured for equipment inheritance as the first virtual prop. Similarly, the terminal device transmits the second virtual prop (for example, the prop identifier of the second virtual prop) to the server when detecting a selection operation of selecting the second virtual prop from the at least one candidate virtual prop by the gamer, and the server records the second virtual prop to be configured for equipment inheritance. The server compares a prop level of the first virtual prop with a prop level of the second virtual prop, to obtain a comparison result. If the comparison result indicates that the prop level of the first virtual prop is higher than the prop level of the second virtual prop, prop inheritance may be performed between the first virtual prop and the second virtual prop. In this case, the server transmits a notification message to the terminal device. The notification message indicates that the prop level of the first virtual prop is higher than the prop level of the second virtual prop. In this way, the terminal device may display prop information of the first virtual prop and a skill special effect set of the second virtual prop together in the first display region in response to the notification message, so that the gamer intuitively senses that the skill special effect set of the second virtual prop is transferred to the first virtual prop. On the contrary, if the comparison result indicates that the prop level of the first virtual prop is lower than the prop level of the second virtual prop, prop inheritance cannot be performed between the first virtual prop and the second virtual prop. In this case, the server returns feedback information to the terminal device. The feedback information indicates that the prop level of the first virtual prop is lower than the prop level of the second virtual prop. In this way, the terminal device may output the feedback information on a terminal screen, so that the gamer reselects the second virtual prop based on the feedback information. By using the foregoing prop level comparison mechanism, it can be ensured that during prop inheritance, the skill special effect set of the second virtual prop of a lower prop level is always inherited to the first virtual prop of a higher prop level, thereby helping the gamer continue to cultivate the first virtual prop of a higher prop level, and improving game experience of the gamer.

Further, if the prop level of the second virtual prop is lower than the prop level of the first virtual prop, the terminal device outputs the confirmation prompt information if the terminal device detects a trigger operation of the gamer on the confirmation option in the third display region, so that the gamer determines again whether the skill special effect set of the second virtual prop needs to be transferred to the first virtual prop. If the gamer performs a confirmation operation on the confirmation prompt information, the terminal device transmits a first message to the server. The first message instructs the gamer to confirm to perform prop inheritance between the first virtual prop and the second virtual prop. The server may recycle the second virtual prop and transfer the skill special effect set of the second virtual prop to the first virtual prop. If the gamer performs a negative operation on the confirmation prompt information, that is, the gamer does not perform prop inheritance between the first virtual prop and the second virtual prop, the terminal device transmits a second message to the server. The second message indicates that the gamer does not need to perform prop inheritance between the first virtual prop and the second virtual prop. The server retains the second virtual prop, and does not transfer the skill special effect set of the second virtual prop to the first virtual prop.

In conclusion, in this embodiment of this application, in addition to supporting lossless transfer of the skill special effect set of the cultivated second virtual prop to the first virtual prop, flexibility of transferring a skill special effect set between virtual props is improved. After the gamer triggers to transfer the skill special effect set of the second virtual prop to the first virtual prop, the confirmation prompt information can be outputted again, so that the gamer determines again whether to perform inheritance, thereby avoiding transfer of the skill special effect set caused by a misoperation of the gamer.

The foregoing describes the method in embodiments of this application in detail. For ease of better implementing the foregoing solution in embodiments of this application, the following correspondingly provides an apparatus in embodiments of this application. In embodiments of this application, a term “module” or “unit” means a computer program with a preset function or a part of the computer program that works together with other related parts, to implement a preset target, and may be completely or partially implemented by using software, hardware (for example, a processing circuit or a memory) or a combination thereof. Similarly, one processor (or a plurality of processors or memories) may be configured to implement at least one module or unit. In addition, each module or unit may be a part of an overall module or unit including a function of the module or unit.

FIG. 19 is a diagram of a structure of a game processing apparatus according to an exemplary embodiment of this application. The game processing apparatus may be configured to perform some or all operations in the method embodiments shown in FIG. 2 and FIG. 13. Refer to FIG. 19. The apparatus includes the following units:
a display unit 1901, configured to display a first virtual prop obtained by a virtual character in a virtual scene, the virtual character being associated with at least one candidate virtual prop, and a prop type of the candidate virtual prop being the same as a prop type of the first virtual prop; and
a processing unit 1902, configured to receive a selection operation on a second virtual prop in the at least one candidate virtual prop, the second virtual prop having a skill special effect set, the skill special effect set including a special effect resource corresponding to a game skill, and the virtual character equipped with the second virtual prop, when using the game skill in the virtual scene, having skill strength that matches the special effect resource.

The processing unit 1902 is further configured to transfer the skill special effect set of the second virtual prop to the first virtual prop, after the skill special effect set is transferred, the first virtual prop having the skill special effect set, and the virtual character equipped with the first virtual prop, when using the game skill in the virtual scene, having skill strength that matches the special effect resource.

In an implementation, the skill special effect set of the second virtual prop includes N special effect groups, N is a positive integer, and one special effect group corresponds to one game skill.

The special effect group includes a special effect resource corresponding to a corresponding game skill, and a quantity of special effect resources included in the special effect group is positively correlated with skill strength of the corresponding game skill.

The game skill obtains a special effect package when the quantity of special effect resources included in the special effect group reaches an upper limit; skill strength of the special effect package is a sum of skill strength during the quantity of special effect resources corresponding to the game skill being the upper limit and reference skill strength; the reference skill strength is skill strength added to the game skill when the quantity of special effect resources included in the special effect group reaches the upper limit; and the upper limit is positively correlated with a prop level of a virtual prop.

In an implementation, when configured to display the first virtual prop obtained by the virtual character in the virtual scene, the display unit 1901 is specifically configured to:
display a game access interface of a game, the game access interface including a first access component configured to access a virtual prop of the virtual character;
display a virtual prop interface of the virtual character in response to a trigger operation on the first access component, the virtual prop interface including a second access component configured to access a prop inheritance system; and

if the second access component is in a selected state, display, in the virtual prop interface, the first virtual prop obtained by the virtual character in the virtual scene.

If the virtual character has a virtual prop that is capable of prop inheritance, prompt information is displayed on the first access component and the second access component, and the prompt information is configured for prompting that the virtual character has the virtual prop that is capable of prop inheritance.

In an implementation, the virtual prop interface includes a prop selection region, the prop selection region is configured for presenting a virtual prop that the virtual character has been equipped with, and a manner of determining the first virtual prop displayed in the virtual prop interface includes:
using a virtual prop selected by default in the prop selection region as the first virtual prop; or
using a selected virtual prop as the first virtual prop in response to a prop selection operation received in the prop selection region.

In an implementation, when configured to display the first virtual prop obtained by the virtual character in the virtual scene, the display unit is specifically configured to:
display a prop prompt window, the prop prompt window including a new target virtual prop obtained by the virtual character in the virtual scene, and the prop prompt window further including a decoration option and a prop inheritance option;
decorate the virtual character with the target virtual prop in response to a selection operation on the decoration option;
display the virtual prop interface of the virtual character when the prop inheritance option is selected; and
display, in the virtual prop interface, the first virtual prop obtained by the virtual character in the virtual scene, the target virtual prop being used as the first virtual prop.

In an implementation, the virtual prop interface includes a first display region, and the first display region is configured for presenting prop information of the first virtual prop; and when configured to display, in the virtual prop interface, the first virtual prop obtained by the virtual character in the virtual scene, the processing unit 1902 is specifically configured to:
display, in the first display region, the prop information of the first virtual prop obtained by the virtual character in the virtual scene.

Prop information of a virtual prop includes at least a prop identifier of the virtual prop, attribute information of the virtual prop, and a skill special effect set of the virtual prop.

In an implementation, the first virtual prop is displayed in the virtual prop interface of the virtual character, and the virtual prop interface further includes a prop selection option; and when configured to receive the selection operation on the second virtual prop in the at least one candidate virtual prop, the processing unit 1902 is specifically configured to:
display a prop presentation window in response to a trigger operation on the prop selection option, the prop presentation window including a prop type and the at least one candidate virtual prop of the same prop type as the first virtual prop; and
receive the selection operation on the second virtual prop in the at least one candidate virtual prop in the prop presentation window.

In an implementation, the first virtual prop is displayed in the virtual prop interface of the virtual character, the virtual prop interface includes a second display region and a third display region, the second display region is configured for presenting the at least one candidate virtual prop of the same prop type as the first virtual prop, and the third display region is configured for presenting prop information of the selected second virtual prop.

When configured to receive the selection operation on the second virtual prop in the at least one candidate virtual prop, the processing unit 1902 is specifically configured to:
select the second virtual prop in the at least one candidate virtual prop based on a selection operation performed in the second display region.

The selection operation includes a trigger operation on the second virtual prop, or a drag operation of moving the second virtual prop from the second display region to the third display region.

In an implementation, the processing unit 1902 is further configured to:
output a preview window in the virtual prop interface in response to a preview operation on any candidate virtual prop in the second display region; and
display prop information of the any candidate virtual prop in the preview window.

The preview operation includes any one of the following: a touch and hold operation on the any candidate virtual prop, or a trigger operation on the any candidate virtual prop; and when the preview operation is a touch and hold operation on the candidate virtual prop, if the touch and hold operation on the candidate virtual prop is canceled, display of the preview window is canceled in the virtual prop interface; or when the preview operation is a trigger operation on the candidate virtual prop, the preview window is displayed in the virtual prop interface in a countdown form.

In an implementation, the at least one candidate virtual prop belongs to a plurality of prop levels; the prop presentation window and the second display region represent a target interface, and the target interface includes level options respectively corresponding to the plurality of prop levels; and the processing unit 1902 is further configured to:
display, in the target interface based on a trigger operation on a level option in the target interface, a candidate virtual prop belonging to a prop level indicated by the triggered level option.

In an implementation, the processing unit 1902 is further configured to:
display prop prompt information corresponding to each candidate virtual prop in the at least one candidate virtual prop in the target interface.

The prop prompt information corresponding to the candidate virtual prop includes at least one of the following: a quantity of skill types of game skills included in the skill special effect set, a quantity of special effect resources included in the skill special effect set, and a quantity of special effect packages included in the skill special effect set.

In an implementation, the first virtual prop is displayed in the virtual prop interface of the virtual character; the virtual prop interface includes the third display region, and the third display region is configured for presenting the prop information of the selected second virtual prop; and the processing unit 1902 is further configured to:
display the prop information of the second virtual prop in the third display region.

In an implementation, the virtual prop interface further includes the first display region, and the first display region is configured for presenting the prop information of the first virtual prop; the third display region includes a confirmation option; and when configured to transfer the skill special effect set of the second virtual prop to the first virtual prop, the processing unit 1902 is specifically configured to:
output confirmation prompt information in the virtual prop interface when the confirmation option is triggered; and
transfer the skill special effect set of the second virtual prop to the first virtual prop in response to a confirmation operation on the confirmation prompt information, the skill special effect set of the second virtual prop being displayed in the first display region after the skill special effect set is transferred.

In an implementation, the processing unit 1902 is further configured to:
separately obtain a prop level of the first virtual prop and a prop level of the second virtual prop;
compare the prop level of the second virtual prop with the prop level of the first virtual prop to obtain a comparison result; and
trigger to perform the operation of transferring the skill special effect set of the second virtual prop to the first virtual prop if the comparison result indicates that the prop level of the second virtual prop is lower than the prop level of the first virtual prop.

In an implementation, the processing unit 1902 is further configured to:
output feedback information if the comparison result indicates that the prop level of the second virtual prop is higher than the prop level of the first virtual prop, the feedback information being configured for prompting a failure of prop inheritance between the first virtual prop and the second virtual prop.

In an implementation, the first virtual prop is displayed in the virtual prop interface of the virtual character; the prop inheritance between the first virtual prop and the second virtual prop is recorded; and the processing unit 1902 is further configured to:
display a query interface in response to a view operation for the prop inheritance in the virtual prop interface, the view operation including any one of the following: a gesture operation, a trigger operation, or a voice input operation; and
display record information of the prop inheritance between the first virtual prop and the second virtual prop in the query interface, the record information including at least the skill special effect set transferred from the second virtual prop to the first virtual prop, a prop identifier of the first virtual prop, a prop identifier of the second virtual prop, attribute information of the first virtual prop, and attribute information of the second virtual prop.

According to an embodiment of this application, the units in the game processing apparatus shown in FIG. 19 may be separately or all combined into one or several other units, or one (or some) of the units may be further divided into a plurality of units of smaller functions. In this way, the same operations can be implemented, and implementation of technical effects of embodiments of this application is not affected. The foregoing units are divided based on logical functions. During actual application, a function of one unit may alternatively be implemented by a plurality of units, or functions of a plurality of units are implemented by one unit. In other embodiments of this application, the game processing apparatus may alternatively include another unit. During actual implementation, these functions may alternatively be implemented with assistance by another unit, and may be implemented with cooperation by a plurality of units. According to another embodiment of this application, the game processing apparatus shown in FIG. 19 may be constructed and the game processing method in embodiments of this application may be implemented by running a computer program (including program code) that can perform the operations involved in the corresponding methods shown in FIG. 2 and FIG. 13 on a general-purpose computing device such as a computer that includes processing elements and storage elements such as a central processing unit (CPU), a random access storage medium (RAM), and a read-only storage medium (ROM). The computer program may be recorded in, for example, a computer-readable recording medium, and may be loaded into the computer device by using the computer-readable recording medium and run in the computer device.

Based on the same inventive concept, problem-resolving principles and beneficial effects of the computer device and the game processing apparatus provided in embodiments of this application are similar to a problem-resolving principle and a beneficial effect of the game processing method in the method embodiment of this application. Reference may be made to the principle and the beneficial effect of the implementation of the method. For concise description, details are not described herein again.

FIG. 20 is a diagram of a structure of a computer device according to an exemplary embodiment of this application. Refer to FIG. 20. The computer device includes a processor 2001, a communication interface 2002, and a non-transitory computer-readable storage medium 2003. The processor 2001, the communication interface 2002, and the computer-readable storage medium 2003 may be connected through a bus or in another manner. The communication interface 2002 is configured to receive and transmit data. The computer-readable storage medium 2003 may be stored in a memory of the computer device. The computer-readable storage medium 2003 is configured to store a computer program. The computer program includes program instructions. The processor 2001 is configured to execute the program instructions stored in the computer-readable storage medium 2003. The processor 2001 (or referred to as a central processing unit (CPU)) is a computing core and a control core of the computer device, is applicable for implementing one or more instructions, and is specifically applicable for loading and executing the one or more instructions to implement a corresponding method procedure or a corresponding function.

An embodiment of this application further provides a non-transitory computer-readable storage medium (memory). The computer-readable storage medium is a storage device in the computer device, and is configured to store a program and data. The computer-readable storage medium herein may include an internal storage medium of the computer device, or certainly may include an extended storage medium supported by the computer device. The computer-readable storage medium provides a storage space, and the storage space stores a processing system of the computer device. In addition, the storage space further stores one or more instructions suitable to be loaded and executed by the processor 2001. These instructions may be at least one computer program (including program code). The computer-readable storage medium herein may be a high-speed RAM memory, or may be a non-volatile memory, for example, at least one magnetic disk memory. In some embodiments, the medium may alternatively be at least one computer-readable storage medium located far away from the foregoing processor.

In an embodiment, the computer device may be the device deployed with the game application mentioned in the foregoing embodiment. The computer-readable storage medium stores one or more instructions. The processor 2001 loads and executes the one or more instructions stored in the computer-readable storage medium, to implement corresponding operations in the foregoing game processing method embodiment. During specific implementation, the one or more instructions in the computer-readable storage medium are loaded by the processor 2001 to perform the following operations:
displaying a first virtual prop obtained by a virtual character in a virtual scene, the virtual character being associated with at least one candidate virtual prop, and a prop type of the candidate virtual prop being the same as a prop type of the first virtual prop;
receiving a selection operation on a second virtual prop in the at least one candidate virtual prop, the second virtual prop having a skill special effect set, the skill special effect set including a special effect resource corresponding to a game skill, and the virtual character equipped with the second virtual prop, when using the game skill in the virtual scene, having skill strength that matches the special effect resource; and
transferring the skill special effect set of the second virtual prop to the first virtual prop, after the skill special effect set is transferred, the first virtual prop having the skill special effect set, and the virtual character equipped with the first virtual prop, when using the game skill in the virtual scene, having skill strength that matches the special effect resource.

In an implementation, the skill special effect set of the second virtual prop includes N special effect groups, N is a positive integer, and one special effect group corresponds to one game skill.

The special effect group includes a special effect resource corresponding to a corresponding game skill, and a quantity of special effect resources included in the special effect group is positively correlated with skill strength of the corresponding game skill.

The game skill obtains a special effect package when the quantity of special effect resources included in the special effect group reaches an upper limit; skill strength of the special effect package is a sum of skill strength during the quantity of special effect resources corresponding to the game skill being the upper limit and reference skill strength; the reference skill strength is skill strength added to the game skill when the quantity of special effect resources included in the special effect group reaches the upper limit; and the upper limit is positively correlated with a prop level of a virtual prop.

In an implementation, when the one or more instructions in the computer-readable storage medium are loaded by the processor 2001 to display the first virtual prop obtained by the virtual character in the virtual scene, the following operations are specifically performed:
displaying a game access interface of a game, the game access interface including a first access component configured to access a virtual prop of the virtual character;
displaying a virtual prop interface of the virtual character in response to a trigger operation on the first access component, the virtual prop interface including a second access component configured to access a prop inheritance system; and
if the second access component is in a selected state, displaying, in the virtual prop interface, the first virtual prop obtained by the virtual character in the virtual scene.
If the virtual character has a virtual prop that is capable of prop inheritance, prompt information is displayed on the first access component and the second access component, and the prompt information is configured for prompting that the virtual character has the virtual prop that is capable of prop inheritance.

In an implementation, the virtual prop interface includes a prop selection region, the prop selection region is configured for presenting a virtual prop that the virtual character has been equipped with, and a manner of determining the first virtual prop displayed in the virtual prop interface includes:
using a virtual prop selected by default in the prop selection region as the first virtual prop; or
using a selected virtual prop as the first virtual prop in response to a prop selection operation received in the prop selection region.

In an implementation, when the one or more instructions in the computer-readable storage medium are loaded by the processor 2001 to display the first virtual prop obtained by the virtual character in the virtual scene, the following operations are specifically performed:
displaying a prop prompt window, the prop prompt window including a new target virtual prop obtained by the virtual character in the virtual scene, and the prop prompt window further including a decoration option and a prop inheritance option;
equipping the virtual character with the target virtual prop in response to a selection operation on the decoration option;
displaying the virtual prop interface of the virtual character when the prop inheritance option is selected; and
displaying, in the virtual prop interface, the first virtual prop obtained by the virtual character in the virtual scene, the target virtual prop being used as the first virtual prop.

In an implementation, the virtual prop interface includes a first display region, and the first display region is configured for presenting prop information of the first virtual prop; and when the one or more instructions in the computer-readable storage medium are loaded by the processor 2001 to display, in the virtual prop interface, the first virtual prop obtained by the virtual character in the virtual scene, the following operation is specifically performed:
displaying, in the first display region, the prop information of the first virtual prop obtained by the virtual character in the virtual scene.

Prop information of a virtual prop includes at least a prop identifier of the virtual prop, attribute information of the virtual prop, and a skill special effect set of the virtual prop.

In an implementation, the first virtual prop is displayed in the virtual prop interface of the virtual character, and the virtual prop interface further includes a prop selection option; and when the one or more instructions in the computer-readable storage medium are loaded by the processor 2001 to receive the selection operation on the second virtual prop in the at least one candidate virtual prop, the following operations are specifically performed:
displaying a prop presentation window in response to a trigger operation on the prop selection option, the prop presentation window including a prop type and the at least one candidate virtual prop of the same prop type as the first virtual prop; and
receiving the selection operation on the second virtual prop in the at least one candidate virtual prop in the prop presentation window.

In an implementation, the first virtual prop is displayed in the virtual prop interface of the virtual character, the virtual prop interface includes a second display region and a third display region, the second display region is configured for presenting the at least one candidate virtual prop of the same prop type as the first virtual prop, and the third display region is configured for presenting prop information of the selected second virtual prop.

When the one or more instructions in the computer-readable storage medium are loaded by the processor 2001 to receive the selection operation on the second virtual prop in the at least one candidate virtual prop, the following operation is specifically performed:
selecting the second virtual prop in the at least one candidate virtual prop based on a selection operation performed in the second display region.

The selection operation includes a trigger operation on the second virtual prop, or a drag operation of moving the second virtual prop from the second display region to the third display region.

In an implementation, the one or more instructions in the computer-readable storage medium are loaded by the processor 2001 to further perform the following operations:
outputting a preview window in the virtual prop interface in response to a preview operation on any candidate virtual prop in the second display region; and
displaying prop information of the any candidate virtual prop in the preview window.

The preview operation includes any one of the following: a touch and hold operation on the any candidate virtual prop, or a trigger operation on the any candidate virtual prop; and when the preview operation is a touch and hold operation on the candidate virtual prop, if the touch and hold operation on the candidate virtual prop is canceled, display of the preview window is canceled in the virtual prop interface; or when the preview operation is a trigger operation on the candidate virtual prop, the preview window is displayed in the virtual prop interface in a countdown form.

In an implementation, the at least one candidate virtual prop belongs to a plurality of prop levels; the prop presentation window and the second display region represent a target interface, and the target interface includes level options respectively corresponding to the plurality of prop levels; and the one or more instructions in the computer-readable storage medium are loaded by the processor 2001 to further perform the following operation:
displaying, in the target interface based on a trigger operation on a level option in the target interface, a candidate virtual prop belonging to a prop level indicated by the triggered level option.

In an implementation, the one or more instructions in the computer-readable storage medium are loaded by the processor 2001 to further perform the following operation:
displaying prop prompt information corresponding to each candidate virtual prop in the at least one candidate virtual prop in the target interface.

The prop prompt information corresponding to the candidate virtual prop includes at least one of the following: a quantity of skill types of game skills included in the skill special effect set, a quantity of special effect resources included in the skill special effect set, and a quantity of special effect packages included in the skill special effect set.

In an implementation, the first virtual prop is displayed in the virtual prop interface of the virtual character; the virtual prop interface includes the third display region, and the third display region is configured for presenting the prop information of the selected second virtual prop; and the one or more instructions in the computer-readable storage medium are loaded by the processor 2001 to further perform the following operation:
displaying the prop information of the second virtual prop in the third display region.

In an implementation, the virtual prop interface further includes the first display region, and the first display region is configured for presenting the prop information of the first virtual prop; the third display region includes a confirmation option; and when the one or more instructions in the computer-readable storage medium are loaded by the processor 2001 to transfer the skill special effect set of the second virtual prop to the first virtual prop, the following operations are specifically performed:
outputting confirmation prompt information in the virtual prop interface when the confirmation option is triggered; and
transferring the skill special effect set of the second virtual prop to the first virtual prop in response to a confirmation operation on the confirmation prompt information, the skill special effect set of the second virtual prop being displayed in the first display region after the skill special effect set is transferred.

In an implementation, the one or more instructions in the computer-readable storage medium are loaded by the processor 2001 to further perform the following operations:
separately obtaining a prop level of the first virtual prop and a prop level of the second virtual prop;
comparing the prop level of the second virtual prop with the prop level of the first virtual prop to obtain a comparison result; and
triggering to perform the operation of transferring the skill special effect set of the second virtual prop to the first virtual prop if the comparison result indicates that the prop level of the second virtual prop is lower than the prop level of the first virtual prop.

In an implementation, the one or more instructions in the computer-readable storage medium are loaded by the processor 2001 to further perform the following operation:
outputting feedback information if the comparison result indicates that the prop level of the second virtual prop is higher than the prop level of the first virtual prop, the feedback information being configured for prompting a failure of prop inheritance between the first virtual prop and the second virtual prop.

In an implementation, the first virtual prop is displayed in the virtual prop interface of the virtual character; the prop inheritance between the first virtual prop and the second virtual prop is recorded; and the one or more instructions in the computer-readable storage medium are loaded by the processor 2001 to further perform the following operations:
displaying a query interface in response to a view operation for the prop inheritance in the virtual prop interface, the view operation including any one of the following: a gesture operation, a trigger operation, or a voice input operation; and
displaying record information of the prop inheritance between the first virtual prop and the second virtual prop in the query interface, the record information including at least the skill special effect set transferred from the second virtual prop to the first virtual prop, a prop identifier of the first virtual prop, a prop identifier of the second virtual prop, attribute information of the first virtual prop, and attribute information of the second virtual prop.

Based on the same inventive concept, a problem-resolving principle and a beneficial effect of the computer device provided in embodiments of this application are similar to a problem-resolving principle and a beneficial effect of the game processing method in the method embodiment of this application. Reference may be made to the principle and the beneficial effect of the implementation of the method. For concise description, details are not described herein again.

An embodiment of this application further provides a non-transitory computer-readable storage medium, having a computer program stored therein. The computer program is configured to be loaded by a processor to perform the foregoing game processing method.

A person of ordinary skill in the art may be aware that, in combination with the examples described in embodiments disclosed in this application, units and algorithm steps may be implemented by using electronic hardware or a combination of computer software and electronic hardware. Whether the functions are performed by hardware or software depends on particular applications and design constraint conditions of the technical solutions. A person skilled in the art may use different methods to implement the described functions for each particular application, but it is not considered that the implementation goes beyond the scope of this application.

All or some of the foregoing embodiments may be implemented by using software, hardware, firmware, or any combination thereof. When software is used for implementation, all or some of embodiments may be implemented in a form of a computer program product. The computer program product includes at least one computer instruction. When the computer program instructions are loaded and executed on a computer, all or some of the procedures or functions according to embodiments of this application are generated. The computer may be a general-purpose computer, a special-purpose computer, a computer network, or any other programmable device. The computer instructions may be stored in the computer-readable storage medium or transmitted through the computer-readable storage medium. For example, the computer instructions may be transmitted from a website, computer, server, or data center to another website, computer, server, or data center in a wired (for example, a coaxial cable, an optical fiber, or a digital subscriber line (DSL) or wireless (for example, infrared, radio, or microwave) manner. The computer-readable storage medium may be any usable medium accessible by the computer, or a data storage device, such as a server or a data center, integrating at least one usable medium. The usable medium may be a magnetic medium (for example, a floppy disk, a hard disk, or a magnetic tape), an optical medium (for example, a DVD), a semiconductor medium (for example, a solid-state drive (SSD)), or the like.

The implementations described above are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A game processing method performed by a computer device, the method comprising:
displaying a first virtual prop obtained by a virtual character in a virtual scene, the virtual character being associated with at least one candidate virtual prop, and a prop type of the candidate virtual prop being the same as a prop type of the first virtual prop;
receiving a selection operation on a second virtual prop in the at least one candidate virtual prop, the second virtual prop having a skill special effect set, the skill special effect set comprising a special effect resource corresponding to a game skill; and
transferring the skill special effect set of the second virtual prop to the first virtual prop, wherein the virtual character equipped with the first virtual prop, when using the game skill in the virtual scene, has skill strength that matches the special effect resource.

2. The method according to claim 1, wherein the virtual character equipped with the second virtual prop, when using the game skill in the virtual scene, has skill strength that matches the special effect resource.

3. The method according to claim 1, wherein the skill special effect set of the second virtual prop comprises N special effect groups, N is a positive integer, and one special effect group corresponds to one game skill.

4. The method according to claim 3, wherein:
each special effect group comprises a special effect resource having a corresponding game skill, and a quantity of special effect resources comprised in the special effect group is positively correlated with skill strength of the corresponding game skill; and
each game skill obtains a special effect package when the quantity of special effect resources comprised in the special effect group reaches an upper limit; skill strength of the special effect package is a sum of skill strength during the quantity of special effect resources corresponding to the game skill being the upper limit and reference skill strength; the reference skill strength is skill strength added to the game skill when the quantity of special effect resources comprised in the special effect group reaches the upper limit; and the upper limit is positively correlated with a prop level of a virtual prop.

5. The method according to claim 1, wherein the displaying a first virtual prop obtained by a virtual character in a virtual scene comprises:
displaying a game access interface of a game, the game access interface comprising a first access component configured to access a virtual prop of the virtual character;
displaying a virtual prop interface of the virtual character in response to a trigger operation on the first access component, the virtual prop interface comprising a second access component configured to access a prop inheritance system; and
when the second access component is in a selected state, displaying, in the virtual prop interface, the first virtual prop obtained by the virtual character in the virtual scene.

6. The method according to claim 1, wherein the displaying a first virtual prop obtained by a virtual character in a virtual scene comprises:
displaying a prop prompt window, the prop prompt window comprising a new target virtual prop obtained by the virtual character in the virtual scene, and the prop prompt window further comprising a decoration option and a prop inheritance option;
equipping the virtual character with the target virtual prop in response to a selection operation on the decoration option;
displaying the virtual prop interface of the virtual character when the prop inheritance option is selected; and
displaying, in the virtual prop interface, the first virtual prop obtained by the virtual character in the virtual scene, the target virtual prop being used as the first virtual prop.

7. The method according to claim 6, wherein the virtual prop interface comprises a first display region, and the first display region is configured for presenting prop information of the first virtual prop; and the displaying, in the virtual prop interface, the first virtual prop obtained by the virtual character in the virtual scene comprises:
displaying, in the first display region, the prop information of the first virtual prop obtained by the virtual character in the virtual scene,
prop information of a virtual prop comprising at least a prop identifier of the virtual prop, attribute information of the virtual prop, and a skill special effect set of the virtual prop.

8. The method according to claim 1, further comprising:
outputting a preview window in the virtual prop interface in response to a preview operation on any candidate virtual prop in the second display region; and
displaying prop information of the any candidate virtual prop in the preview window,
the preview operation comprising any one of the following: a touch and hold operation on the any candidate virtual prop, or a trigger operation on the any candidate virtual prop; and when the preview operation is a touch and hold operation on the candidate virtual prop, if the touch and hold operation on the candidate virtual prop is canceled, display of the preview window being canceled in the virtual prop interface; or when the preview operation is a trigger operation on the candidate virtual prop, the preview window being displayed in the virtual prop interface in a countdown form.

9. The method according to claim 8, wherein the at least one candidate virtual prop belongs to a plurality of prop levels; the prop presentation window and the second display region are represented as target interfaces; the target interface comprises level options respectively corresponding to the plurality of prop levels; and the method further comprises:
displaying, in the target interface based on a trigger operation on a level option in the target interface, a candidate virtual prop belonging to a prop level indicated by the triggered level option.

10. The method according to claim 1, further comprising:
displaying prop prompt information corresponding to each candidate virtual prop in the at least one candidate virtual prop in the target interface,
the prop prompt information corresponding to the candidate virtual prop comprising at least one of the following: a quantity of skill types of game skills comprised in the skill special effect set, a quantity of special effect resources comprised in the skill special effect set, and a quantity of special effect packages comprised in the skill special effect set.

11. The method according to claim 1, wherein the transferring the skill special effect set of the second virtual prop to the first virtual prop further comprises:
separately obtaining a prop level of the first virtual prop and a prop level of the second virtual prop;
comparing the prop level of the second virtual prop with the prop level of the first virtual prop to obtain a comparison result; and
transferring the skill special effect set of the second virtual prop to the first virtual prop when the comparison result indicates that the prop level of the second virtual prop is lower than the prop level of the first virtual prop.

12. The method according to claim 11, further comprising:
outputting feedback information if the comparison result indicates that the prop level of the second virtual prop is higher than the prop level of the first virtual prop, the feedback information being configured for prompting a failure of prop inheritance between the first virtual prop and the second virtual prop.

13. The method according to claim 12, wherein the first virtual prop is displayed in the virtual prop interface of the virtual character; the prop inheritance between the first virtual prop and the second virtual prop is recorded; and the method further comprises:
displaying a query interface in response to a view operation for the prop inheritance in the virtual prop interface, the view operation comprising any one of the following: a gesture operation, a trigger operation, or a voice input operation; and
displaying record information of the prop inheritance between the first virtual prop and the second virtual prop in the query interface, the record information comprising at least the skill special effect set transferred from the second virtual prop to the first virtual prop, a prop identifier of the first virtual prop, a prop identifier of the second virtual prop, attribute information of the first virtual prop, and attribute information of the second virtual prop.

14. A computer device, comprising:
a processor, applicable for executing a computer program; and
a computer-readable storage medium, having a computer program stored therein, the computer program, when executed by the processor, causing the computer device to implement a game processing method including:
displaying a first virtual prop obtained by a virtual character in a virtual scene, the virtual character being associated with at least one candidate virtual prop, and a prop type of the candidate virtual prop being the same as a prop type of the first virtual prop;
receiving a selection operation on a second virtual prop in the at least one candidate virtual prop, the second virtual prop having a skill special effect set, the skill special effect set comprising a special effect resource corresponding to a game skill; and
transferring the skill special effect set of the second virtual prop to the first virtual prop, wherein the virtual character equipped with the first virtual prop, when using the game skill in the virtual scene, has skill strength that matches the special effect resource.

15. The computer device according to claim 14, wherein the virtual character equipped with the second virtual prop, when using the game skill in the virtual scene, has skill strength that matches the special effect resource.

16. The computer device according to claim 14, wherein the displaying a first virtual prop obtained by a virtual character in a virtual scene comprises:
displaying a game access interface of a game, the game access interface comprising a first access component configured to access a virtual prop of the virtual character;
displaying a virtual prop interface of the virtual character in response to a trigger operation on the first access component, the virtual prop interface comprising a second access component configured to access a prop inheritance system; and
when the second access component is in a selected state, displaying, in the virtual prop interface, the first virtual prop obtained by the virtual character in the virtual scene.

17. The computer device according to claim 14, wherein the displaying a first virtual prop obtained by a virtual character in a virtual scene comprises:
displaying a prop prompt window, the prop prompt window comprising a new target virtual prop obtained by the virtual character in the virtual scene, and the prop prompt window further comprising a decoration option and a prop inheritance option;
equipping the virtual character with the target virtual prop in response to a selection operation on the decoration option;
displaying the virtual prop interface of the virtual character when the prop inheritance option is selected; and
displaying, in the virtual prop interface, the first virtual prop obtained by the virtual character in the virtual scene, the target virtual prop being used as the first virtual prop.

18. The computer device according to claim 14, wherein the method further comprises:
outputting a preview window in the virtual prop interface in response to a preview operation on any candidate virtual prop in the second display region; and
displaying prop information of the any candidate virtual prop in the preview window,
the preview operation comprising any one of the following: a touch and hold operation on the any candidate virtual prop, or a trigger operation on the any candidate virtual prop; and when the preview operation is a touch and hold operation on the candidate virtual prop, if the touch and hold operation on the candidate virtual prop is canceled, display of the preview window being canceled in the virtual prop interface; or when the preview operation is a trigger operation on the candidate virtual prop, the preview window being displayed in the virtual prop interface in a countdown form.

19. The computer device according to claim 14, wherein the transferring the skill special effect set of the second virtual prop to the first virtual prop further comprises:
separately obtaining a prop level of the first virtual prop and a prop level of the second virtual prop;
comparing the prop level of the second virtual prop with the prop level of the first virtual prop to obtain a comparison result; and
transferring the skill special effect set of the second virtual prop to the first virtual prop when the comparison result indicates that the prop level of the second virtual prop is lower than the prop level of the first virtual prop.

20. A non-transitory computer-readable storage medium, having a computer program stored therein, the computer program, when being configured to be loaded by a processor of a computer device, causing the computer device to perform a game processing method including:
displaying a first virtual prop obtained by a virtual character in a virtual scene, the virtual character being associated with at least one candidate virtual prop, and a prop type of the candidate virtual prop being the same as a prop type of the first virtual prop;
receiving a selection operation on a second virtual prop in the at least one candidate virtual prop, the second virtual prop having a skill special effect set, the skill special effect set comprising a special effect resource corresponding to a game skill; and
transferring the skill special effect set of the second virtual prop to the first virtual prop, wherein the virtual character equipped with the first virtual prop, when using the game skill in the virtual scene, has skill strength that matches the special effect resource.
